(19) United States
(12) Patent Application Publication
(10) Pub. No.: US 2025/0181228 A1
(43) Pub. Date: Jun. 5, 2025

(54) IMAGE PROCESSING METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Dehui LI, Shenzhen (CN)

(73) Assignee: Tencent Technology (Shenzhen) Company Limited, Shenzhen (CN)

(21) Appl. No.: 19/042,077

(22) Filed: Jan. 31, 2025

Related U.S. Application Data
(63) Continuation of application No. PCT/CN2023/127613, filed on Oct. 30, 2023.

(30) Foreign Application Priority Data
Nov. 16, 2023 (CN) 202310106891.8

(51) Int. Cl. G06F 3/04845

(52) U.S. Cl. CPC G06F 3/04845

(57) ABSTRACT

An image processing method, executed by a computer device, including displaying an image editing interface, displaying a target image on the image editing interface, the target image comprising a face, the face having a face part and a face appearance attribute, and the face part comprising a target face part to be blocked, and displaying, on the target face part, a target blocking object blocking the target face part, the face on which the target face part is blocked maintains the face appearance attribute.

### CROSS-REFERENCE TO RELATED APPLICATIONS

This application is a continuation application of International Application No. PCT/CN2023/127613 filed on Oct. 30, 2023, which claims priority to Chinese Patent Application No. 202310106891.8 filed with the China National Intellectual Property Administration on Jan. 16, 2023, the disclosures of each being incorporated by reference herein in their entireties.

### FIELD

The disclosure relates to the field of computer technologies, in particular, to the field of artificial intelligence, and specifically, to an image processing method, an image processing apparatus, a computer device, a computer-readable storage medium, and a computer program product.

### BACKGROUND

Image masking refers to a process in which sensitive information (for example, information such as a face, an identification number, or a vehicle license plate) in an image is removed.

In a conventional technology, when masking processing is performed on a face, the face is usually pixelated, and a region on the face is processed into a plurality of color blocks with large differences, so that the original face cannot be recognized.

However, the face masking method of pixelating the face is rough, the pixelated region is very noticeable in an image, and there is a distinct image processing trace.

### SUMMARY

Some embodiments provides an image processing method, execute by a computer device, the method including: displaying an image editing interface; displaying a target image on the image editing interface, the target image comprising a face, the face having a face part and a face appearance attribute, and the face part comprising a target face part to be blocked; and displaying, on the target face part, a target blocking object blocking the target face part, the face on which the target face part is blocked maintaining the face appearance attribute.

Some embodiments provide an image processing apparatus, including: at least one memory configured to store computer program code; and at least one processor configured to read the program code and operate as instructed by the program code, the program code comprising: interface display code configured to cause at least one of the at least one processor to display an image editing interface; and display a target image on the image editing interface, the target image comprising a face, the face having a face part and a face appearance attribute, and the face part comprising a target face part to be blocked; and blocking object display code configured to cause at least one of the at least one processor to display, on the target face part, a target blocking object blocking the target face part, the face on which the target face part is blocked maintaining the face appearance attribute.

Some embodiments provide a non-transitory computer-readable storage medium, storing computer code which, when executed by at least one processor, causes the at least one processor to at least: display an image editing interface; display a target image on the image editing interface, the target image comprising a face, the face having a face part and a face appearance attribute, and the face part comprising a target face part to be blocked; and display, on the target face part, a target blocking object blocking the target face part, the face on which the target face part is blocked maintaining the face appearance attribute.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of existing face masking.

FIG. 2 is a schematic diagram of face masking of blocking a target face part in a face by using a target blocking object according to some embodiments.

FIG. 3 is a schematic diagram of an architecture of an image processing system according to some embodiments.

FIG. 4 is a schematic diagram of another architecture of an image processing system according to some embodiments.

FIG. 5 is a schematic flowchart of an image processing method according to some embodiments.

FIG. 6 is a schematic diagram of selecting, as a target image on which face masking is to be performed, one or more video frames from a video according to some embodiments.

FIG. 7 is a schematic diagram of a face on which a nose part and a mouth part on the face are blocked by a face mask according to some embodiments.

FIG. 8 is a schematic diagram in which a blocking trigger operation is a trigger operation for a part removal option according to some embodiments.

FIG. 9 is a schematic diagram in which a user autonomously selects a face part on which masking is to be performed according to some embodiments.

FIG. 10 is a schematic diagram in which a blocking trigger operation is a gesture operation on an image editing interface according to some embodiments.

FIG. 11 is a schematic diagram in which a blocking trigger operation is a speech-signal input operation on an image editing interface according to some embodiments.

FIG. 12 is a schematic diagram of masking prompt information according to some embodiments.

FIG. 13 is a schematic diagram of blocking prompt information according to some embodiments.

FIG. 14 is a schematic diagram in which blocking prompt information is displayed in a prompt window according to some embodiments.

FIG. 15 is a schematic diagram in which a user autonomously selects an object style of a target blocking object according to some embodiments.

FIG. 16 is a schematic flowchart of another image processing method according to some embodiments.

FIG. 17 is a schematic flowchart of implementing face masking on a target image by using a face detection network and a face conversion network that are trained according to some embodiments.

FIG. 18 is a schematic diagram of annotating a face in an image by using a rectangular box according to some embodiments.

FIG. 19 is a schematic diagram of a network structure of a face detection network according to some embodiments.

FIG. 20 is a schematic diagram of a face conversion data set according to some embodiments

FIG. 21 is a schematic diagram of a structure of a generator network according to some embodiments.

FIG. 22 is a schematic diagram of a structure of a discriminator network according to some embodiments.

FIG. 23 is a schematic flowchart of determining a loss function according to some embodiments.

FIG. 24 is a schematic diagram of a structure of an image processing apparatus according to some embodiments.

FIG. 25 is a schematic diagram of a structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide an image processing solution based on artificial intelligence technologies. The following briefly describes technical terms and related concepts involved in the image processing solution.

### 1. Artificial Intelligence (AI).

The artificial intelligence is a theory, a method, a technology, and an application system that use a digital computer or a machine controlled by the digital computer to simulate, extend, and expand human intelligence, perceive an environment, obtain knowledge, and use the knowledge to obtain an optimal result. In other words, the artificial intelligence is a comprehensive technology of computer science, to attempt to understand an essence of intelligence, and produce a new intelligent machine that can react in a manner similar to that of human intelligence. The artificial intelligence is to study a design principle and an implementation method of various intelligent machines, to enable the machines to have functions of perception, inference, and decision-making. The artificial intelligence technologies are a comprehensive discipline, and relate to a wide range of fields, including both hardware-level technologies and software-level technologies. Basic technologies of the artificial intelligence usually include technologies such as a sensor, a dedicated artificial intelligence chip, cloud computing, distributed storage, big data processing technologies, an operating/interaction system, and mechatronics. Artificial intelligence software technologies mainly include several directions such as computer vision (CV), voice processing technologies, nature language processing technologies, and machine learning (ML)/deep learning (DL).

Some embodiments relate to directions such as computer vision and machine learning in the field of artificial intelligence.

\textcircled{1} Computer vision (CV) is a science for studying how to enable a machine to “see”, and further, refers to using a camera and a computer to replace human eyes in machine vision such as recognizing, tracking, and measuring a target, and further perform graphics processing, so that an image that is more suitable for the human eyes to observe or transmitted to an instrument for detection is obtained through processing by the computer. In the computer vision, which is a scientific discipline, related theories and technologies are researched, to attempt to establish an artificial intelligence system that can obtain information from an image or multi-dimensional data. The computer vision usually includes technologies such as image processing, image recognition, image semantic understanding, image retrieval, optical character recognition (OCR), video processing, video semantic understanding, video content/behavior recognition, three-dimensional (3D) object reconstruction, 3D technologies, virtual reality (VR), augmented reality (AR), synchronous positioning, and map building.

Some embodiments relate to the video semantic understanding (VSU) under the computer vision. The visual semantic understanding may be further subdivided into target detection and localization, target recognition, target tracking, and the like. For example, the image processing solution according to some embodiments may relate to the target detection and localization (which is also referred to as target detection for short) under the video semantic understanding. The target detection is a computer technology related to computer vision and image processing, and is configured for detecting an instance of a semantic object (such as a person, a building, or a car, which refers to a face in some embodiments) of a specific type in a digital image (which is also referred to as an electronic image, and may be referred to as an image for short) and a video.

Machine learning (ML) is a discipline in which a plurality of fields intersect, and relates to a plurality of disciplines such as the probability theory, statistics, the approximation theory, convex analysis, and the computational complexity theory. In the machine learning, how a computer simulates or implements a human learning behavior is specifically studied, to obtain new knowledge or a new skill, and reorganize an existing knowledge structure, so that performance of the computer is continuously improved. The machine learning, as a core of the artificial intelligence, is a basic manner to make a computer intelligent, and is applied throughout various fields of the artificial intelligence. The machine learning and the deep learning usually include technologies such as an artificial neural network, a belief network, reinforcement learning, transfer learning, inductive learning, and demonstration learning. The machine learning may be considered as a task, and an objective of the task is to enable a machine (which is a computer in a broad sense) to obtain human-like intelligence through learning. For example, if a human can recognize a target of interest from an image or a video, a computer program (AlphaGo or AlphaGo Zero) is designed as a program that has a target recognition capability. A plurality of methods may be used to implement a task of the machine learning, for example, a plurality of methods such as a neural network, linear regression, a decision tree, a support vector machine, a Bayes classifier, reinforcement learning, a probabilistic graphical model, and clustering.

The neural network is a method for implementing the task of the machine learning. When the neural network is described in the field of machine learning, the neural network usually refers to “neural network learning”. The neural network is a network structure including many simple elements. The network structure is similar to a biological nervous system and is configured for simulating interaction between a living being and a natural environment. More network structures indicate richer functions of the neural network. The neural network is a large concept. For different learning tasks such as a speech, a text, and an image, a neural network model that is more suitable for a specific learning task is derived, for example, a recurrent neural network (RNN), a convolutional neural network (CNN), and a fully connected convolutional neural network (FCNN).

### 2. Data Masking.

The data masking is processing of shielding sensitive data to protect the sensitive data. The sensitive data may also be referred to as sensitive information. The data masking may be performing data transformation on some sensitive information (for example, information related to personal privacy, such as an identity card number, a mobile phone number, a card number, a customer name, a customer address, an email address, a salary, a face, and a vehicle license plate) according to a masking rule, to reliably protect privacy data. Image masking in some embodiments, is the process of removing sensitive information related to personal privacy in an image. The sensitive information herein refers to a face from which a user identity can be recognized in the image. In other words, the image processing solution provided in some embodiments removes sensitive information such as a face in an image, to protect face privacy.

Based on the related content such as the artificial intelligence and the data masking mentioned above, some embodiments provide a perception-free face masking solution, which is referred to as the image processing solution in some embodiments. In some embodiments, a face detection network and a face conversion network can be obtained through training by using artificial intelligence (for example the machine learning and the computer vision in the field of artificial intelligence), so that target detection (where a target herein refers to a face) is performed on a target image (for example, any image) by using the face detection network, to determine a region in which the face is located in the target image.

Further, the face detected in the target image is removed by using the face conversion network, to implement an image masking process. In some embodiments, a target face part on the face is blocked by a target blocking object (for example, any blocking object such as a face mask). For example, the face mask is worn on a face that does not wear the face mask. Therefore, face sensitive information on the face is removed, to avoid recognizing a user identity based on the face, so that face privacy is protected. In addition, this manner of blocking the target face part on the face by using the target blocking object ensures naturalness of face masking, so that it is difficult for a user to see a face masking trace, and perception-free face masking is implemented. The target face part mentioned above may be any one or more face parts on the face. The face part may include eyebrows, eyes, a nose, a mouth, ears, cheeks, a forehead, and the like.

In comparison with another face masking manner, the image processing solution provided in some embodiments has a distinct advantage. Face masking involved in the image processing solution provided in some embodiments and the another face masking manner are compared and described below.

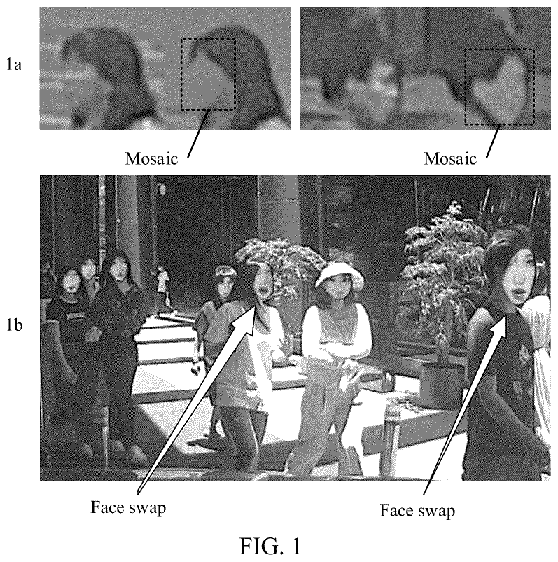

As shown in (a) in FIG. 1, in another face masking manner, which is referred to as a first face masking manner, a region in which a face is located is selected from an image by using a rectangular box, and then information about face privacy is removed in a manner such as filling or smearing the rectangular box by using a mosaic. The rectangular box is a box with a regular shape, but the face usually has a shape with a moderate contour. As a result, the rectangular box covers a region that is not the face and that is a part of the image, causing unnecessary damage to the image, and affecting a subsequent service in some application scenarios. For example, in a scenario in which the image in which the face is removed is used as training data, model training may be negatively affected. In addition, the manner of directly pixelating or smearing the rectangular box is rough, and may affect a service of a downstream product.

As shown in (b) in FIG. 1, in yet another face masking manner, which is referred to as a second face masking manner, replacing a face in an image with a virtual face or an animated face is supported. However, in some scenarios, for example, in a vehicle-mounted view angle, face imaging is small, an operation such as face alignment is difficult to be implemented, a face posture is easily mismatched, and a face swap effect is abrupt and unnatural. In addition, because the face is small and facial features are blurry in the vehicle-mounted view angle, if the face is animated, the facial features are further smoothed, causing an unnatural effect of blurring “no face”.

In conclusion, in the other face masking manners, regardless of whether the face is removed through the mosaic, the smearing, or the animated face, a face removal trace in the image is distinct, which is not conducive to development of a downstream application after face masking. The downstream application is an application in which the image obtained after face masking needs to be used, that is, an application that depends on the image obtained after face masking.

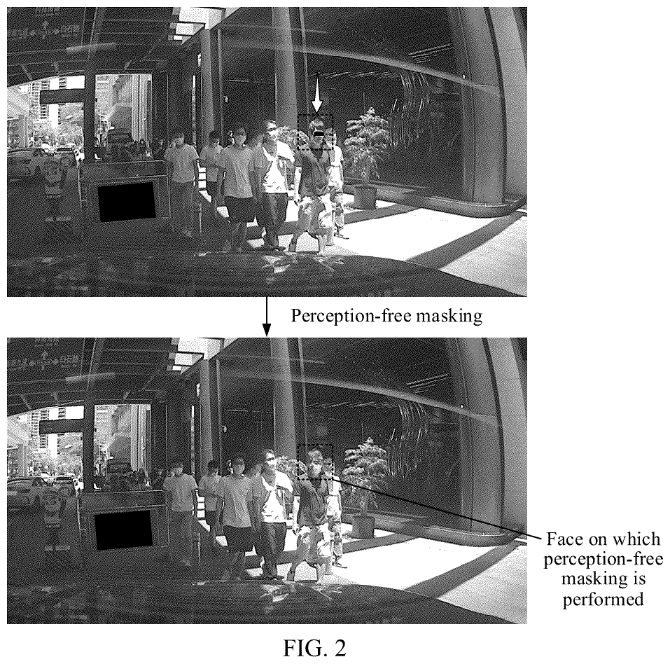

In the image processing according to some embodiments, a part of the face part on the face is blocked by a blocking object. For example, the blocking object is a face mask. In this case, blocking a nose part and a mouth part on the face by using the face mask is supported, and the face on which no face mask is worn is converted into a face on which the face mask is worn, so that a part of private information on the face is removed. In this manner of removing a part of private information on the face, not only the private information on the face can be protected, for example, the use identity cannot be recognized based on an unblocked face part on the face, but also a face appearance attribute of the original face can be maintained on the masked face. As shown in FIG. 2, when a blocking object is a face mask, not only a face on which a mouth and a nose are blocked by the face mask looks very natural, but also face appearance attributes such as a head orientation and a line of sight of the original face are maintained. Therefore, perception-free masking of a user is implemented. The user herein is any user that wants to perform face masking. The perception-free masking refers to that harmony and aesthetics of an image are maintained when sensitive information in the image is removed, and it is difficult to see a masking processing trace. That is, the user cannot notice the masking trace based on a masked image, so that substantial damage to the image is avoided.

Face masking is a necessary means for personal privacy protection. The image processing solution provided in some embodiments may be applied to a target application scenario. The target application scenario may be any application scenario in which face masking is required. For a specific solution, the target application scenario is a specific application scenario. The target application scenario includes, but is not limited to, at least one of the following: a training-image return scenario, a vehicle-mounted scenario, and the like. Related descriptions of processes in which the image processing according to some embodiments is applied are provided below.

### (1) Training-Data Return Scenario.

An image perception algorithm is a type of algorithms that can be used for target detection. For example, targets such as a pedestrian, a vehicle, a lane line, a traffic plate, a traffic light, and a drivable region are detected from an image by using the image perception algorithm. Development and iteration of these perception algorithms require a large amount of image data. In some embodiments, the image data for algorithm training may be from a vehicle. For example, an image capture apparatus such as a camera is deployed on the vehicle, to capture, as the image data for algorithm training, an image by using the image capture apparatus. For example, the image data is obtained by using an image-data capture vehicle dedicated to image capture. For another example, in consideration of a large quantity and wide distribution of vehicles on the market, both a quantity and diversity of the image data are strongly ensured. Therefore, an image captured by a production vehicle is further returned as the image data for algorithm training. However, the image returned from either the image-data capture vehicle or the production vehicle includes sensitive information such as a face, and masking processing needs to be first performed. If the other face masking manners mentioned above such as pixelating or unnatural face swap are used, a distinct image modification trace is generated, which reduces image quality, and is not conducive to training of the perception algorithm. Conversely, when the image processing solution of perception-free masking is used, masking can be implemented when image damage is avoided to a large extent, an algorithm training requirement is better satisfied, and friendliness of algorithm training is improved.

### (2) Vehicle-Mounted Scenario.

In some embodiments, when an image processing method is applied to a vehicle-mounted scenario, the image processing method further includes: displaying face retention prompt information, the face retention prompt information being configured for indicating whether to back up a face on which a target face part is not blocked; and displaying retention notification information in response to a confirmation operation for the face retention prompt information, the retention notification information including retention address information of the face on which the target face part is not blocked.

In some embodiments, the vehicle-mounted scenario includes a parking sentry scenario. For example, when a vehicle is in a parking state, the vehicle may sense a surrounding situation in real time by using a sensor such as a radar. When detecting that there is an abnormal situation in a vicinity of the vehicle, for example, a person approaches, the vehicle notifies the abnormal situation to a vehicle owner in real time. In this case, the vehicle owner may remotely view the situation around the vehicle in real time through a vehicle-mounted camera by using a terminal device, for example, a device such as a smartphone on which an application corresponding to an image capture application running in the vehicle is deployed. In some embodiments, the vehicle-mounted scenario includes a remote automatic parking scenario. For example, in a process in which a vehicle owner remotely parks a vehicle by using a terminal device, an image that is around the vehicle and that is captured in real time needs to be transmitted, by using a vehicle-mounted camera, to the terminal device owned by the vehicle owner. In this way, the vehicle owner can grasp a situation around the vehicle in time through a real-time image outputted by the terminal device, to ensure that the vehicle can safely and correctly parked to a correct location.

In the foregoing process, in both the parking sentry scenario and the remote automatic parking scenario, masking needs to be performed on the image automatically pushed to the vehicle owner. If an image masking trace is excessively severe, aesthetics of the image is greatly reduced and use feeling of the vehicle owner is affected. Therefore, when the image processing solution of perception-free masking is used, a part of the face part on the face is blocked by the blocking object, and the face appearance attribute of the face is maintained, so that a face masking trace can be relieved. Therefore, the vehicle owner basically cannot see the image masking trace, and aesthetics of a real-time video is improved, to help improve competitiveness of a product.

To facilitate viewing of an abnormal situation near a vehicle, locally storing an unmasked image in the vehicle is further supported in some embodiments. In this way, when an abnormal behavior such as stealing or smashing the vehicle is remotely confirmed and a face needs to be confirmed, the unmasked image may be locally viewed in the vehicle, to ensure safety of the vehicle.

In some embodiments, the unmasked image may be locally reserved in the vehicle by default. For example, the unmasked image is locally reserved in the vehicle by default in the target application scenario. In some embodiments, a user may autonomously determine to locally reserve the unmasked image in the vehicle. For example, when the target application scenario is the vehicle-mounted scenario, display of the face retention prompt information is supported. The face retention prompt information is configured for indicating whether to back up the face on which the target face part is not blocked. If the user wants to locally store the unmasked image in the vehicle, the user may perform the confirmation operation for the face retention prompt information. In this case, a computer device displays the retention notification information in response to the confirmation operation for the face retention prompt information. The retention notification information includes the retention address information of the face on which the target face part is not blocked, so that the user can intuitively learn a storage location of the unmasked image in time, to facilitate viewing the image by the user.

The target application scenario to which the friendly (for example, the perception-free masking of sensitive information) image processing solution provided is not limited herein. The image processing solution may be applied to various application scenarios, including but not limited to scenarios such as a cloud technology, artificial intelligence, intelligent transportation, and assisted driving.

For example, the target application scenario may further include a pedestrian flow detection scenario. For example, a pedestrian flow detection device may be deployed in a place with a dense pedestrian flow, and the pedestrian flow detection device transmits a captured environment image to a user (for example, any user having an authority of viewing or managing the pedestrian flow detection device), so that the user can learn an environment situation in time based on the environment image. The pedestrian flow refers to a group formed through aggregation of pedestrians. The pedestrian flow may be quantitatively measured by a pedestrian volume, and the pedestrian volume represents a quantity of pedestrians per unit time.

In the foregoing pedestrian flow detection scenario, face masking also needs to be performed on the environment image transmitted to the user, to ensure face privacy to a certain extent. In addition, an unmasked image is locally stored in the pedestrian flow detection device, so that a face can be confirmed when an abnormal situation needs to be excluded. When some embodiments are applied to a specific product or technology, for example, when an image captured by a vehicle is obtained, information about a vehicle owner (for example, a name or number of the vehicle owner) having an authority of managing the vehicle is inevitably to be obtained. In this case, permission or consent of the vehicle owner needs to be obtained, and collection, use, and processing of related data need to comply with related laws, regulations, and standards of related countries and regions.

In some embodiments, based on different target application scenarios to which the image processing solution is applied, computer devices configured to execute the image processing solution may be different.

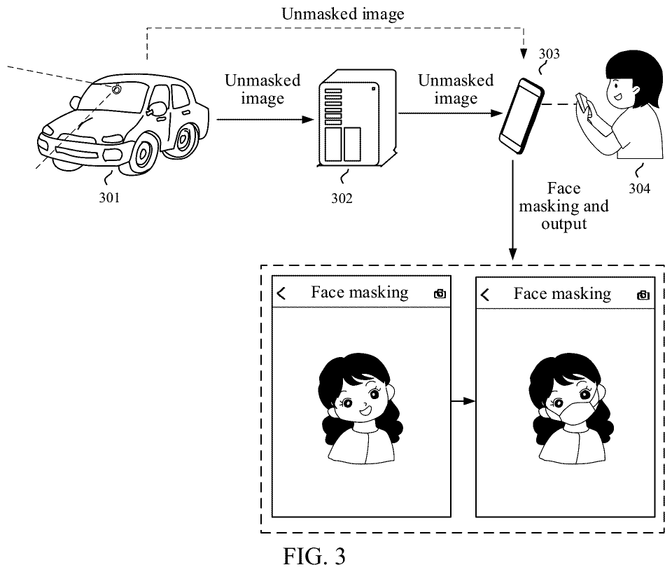

In some embodiments, the computer device may be a terminal device 303 used by a user. As shown in FIG. 3, after a camera deployed on a vehicle 301 transmits a captured image to a background server 302, the background server 302 forwards the image to a terminal device 303 used by a user 304, and the terminal device 303 performs face masking on the image and displays a masked image. In some embodiments, a camera deployed on a vehicle 303 directly transmits a captured image to a terminal device 303, and the terminal device 303 performs face masking on the image and displays a masked image. The terminal device 303 may include, but is not limited to, a smart device with a touchscreen, such as a smartphone (for example, an Android mobile phone or an iOS mobile phone, which may be referred to as a mobile phone for short), a tablet computer (which is also referred to as a computer for short), a portable personal computer, a mobile Internet device (MID for short), a smart voice interaction device, a smart home appliance, a vehicle-mounted device (which is also referred to as a vehicle-mounted terminal), a head-mounted device, or an aircraft.

In some embodiments, the computer device may include a terminal device 403 used by a user 404 and a server (background server) 402 corresponding to the terminal device 403. In other words, the image processing solution may be jointly executed by the terminal device 403 and the background server 402. As shown in FIG. 4, after a camera deployed on a vehicle 401 transmits a captured image to a background server 402, the background server 402 may perform face masking on the image, and send a masked image to a terminal device 403 for masking display. The server may include, but is not limited to, a device with a complex computing capability, such as a data processing server, a Web server, or an application server. The server may be an independent physical server, a server cluster including a plurality of physical servers, or a distributed system. The target terminal device and the server may be connected directly or indirectly in a wired or wireless manner. A connection manner between the target terminal and the computer device is not limited herein.

Further, the image processing solution provided in some embodiments may be executed by an application program or a plug-in deployed in a computer device. As mentioned above, the application program or the plug-in is integrated with a face masking function provided in some embodiments, and the application program or the plug-in may be invoked by using a terminal device to use the face masking function. The application program may be computer-readable instructions that complete one or more specific tasks. When the application program is classified based on different dimensions (such as a running manner and a function of the application program), types of the same application program in different dimensions may be obtained. When classification is performed based on the running manner of the application program, the application program may include, but is not limited to, a client installed in a terminal, an applet that can be used without being downloaded and installed, a web application program opened by using a browser, and the like. When classification is performed based on a function type of the application program, the application program may include, but are not limited to, an instant messaging (IM) application program, a content interaction application program, and the like. The instant messaging application program is an application program for instant messaging and social interaction based on the Internet. The instant messaging application program may include, but is not limited to, a social application program including a communication function, a map application program including a social interaction function, a game application program, and the like. The content interaction application program is an application program that can implement content interaction. For example, the content interaction application program may be an application program such as online banking, a sharing platform, personal space, or news.

A type of application program that is the application program having the face masking function is not limited herein. In addition, for ease of description, an example in which a computer device executes the image processing solution is used for description. Details are described herein.

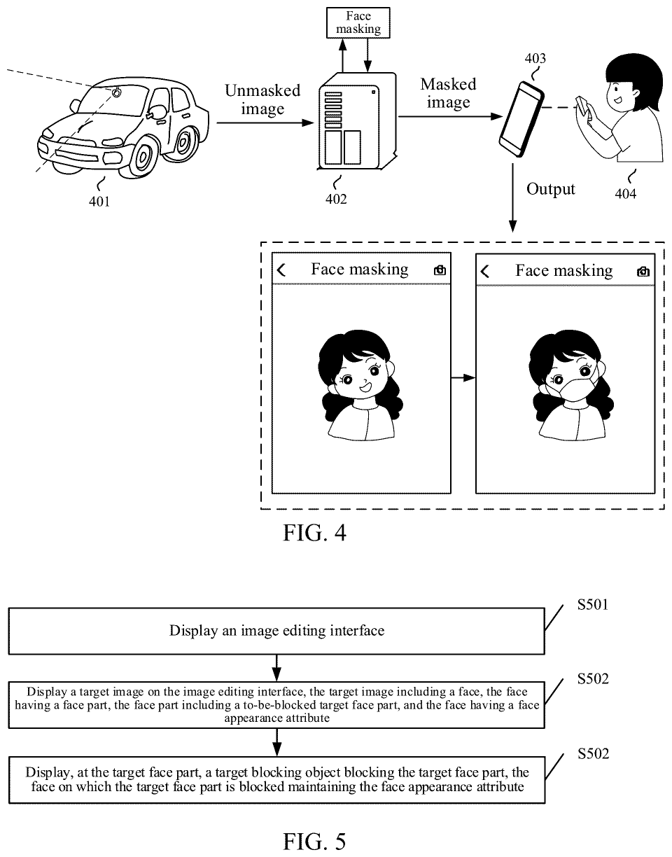

It can be learned based on the foregoing described image processing solution that, implementing face masking by using a face detection network and a face conversion network that are trained is supported in some embodiments, to relieve a face masking trace and ensure naturalness of a masked face. An interface implementation process of a more detailed image processing method provided in some embodiments is first described below with reference to FIG. 5. The image processing method may be executed by a computer device mentioned above, and the image processing method may include, but is not limited to, operations S501 to S503.

S501: Display an image editing interface.

S502: Display a target image on the image editing interface, the target image including a face, the face having a face part, the face part including a to-be-blocked target face part, and the face having a face appearance attribute.

The image editing interface is a user interface (UI) for implementing face masking, and is a medium for interaction and information exchange between a system and a user. As described above, the image processing method according to some embodiments may be integrated into a plug-in or an application program. In this case, the image editing interface may be provided by the plug-in or the application program and displayed by a terminal device on which the plug-in or the application program is deployed. For ease of description, an example in which the image processing method is integrated into an application program is used.

When the user needs to view an image, the user may, according to some embodiments, open the application program by using the terminal device, and the image editing interface provided by the application program is displayed. The face is displayed on the image editing interface. The face belongs to the target image, and the target image is displayed on the image editing interface, to display the face on the image editing interface.

A quantity of faces included on the image editing interface and a quantity of target images included in the image editing interface are not limited herein. For ease of description, an example in which the image editing interface includes a target image and the target image includes an unmasked face is used for description.

A source of the target image on the image editing interface is not limited herein. A source manner of the target image may include, but is not limited to, an image captured in real time by using a camera, an image downloaded from a local internal memory of the terminal device or a network, an image captured from a video (for example, a video captured by a vehicle-mounted configuration), or the like. In some embodiments, the user is supported in obtaining, in a plurality of manners, the target image on which face masking needs to be performed, so that paths for the application program to implement face masking can be enriched, to satisfy a requirement of the user for selecting, in a customized manner, an image for face masking, and improve user experience.

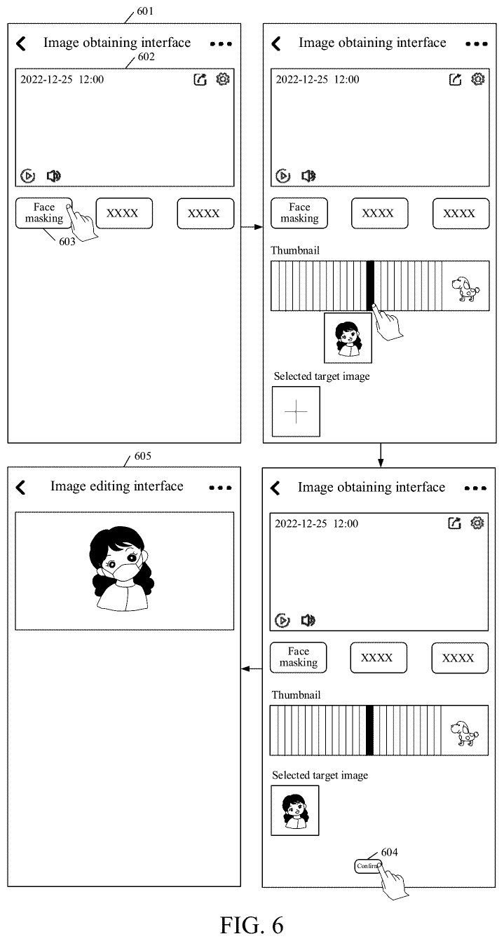

According to different source manners of the target image, implementations of adding the target image to the image editing interface and displaying the target image may be the same or different. An example implementation of capturing the target image from a video is described below with reference to FIG. 6 by using an example in which the source of the target image is that the target image is selected from the video, and constitutes no limitation. As shown in FIG. 6, before an image editing interface provided by a target application program is displayed, an image obtaining interface 601 provided by the application program may be first displayed. The image obtaining interface includes a target video 602 (for example, a video having any duration and captured by a vehicle-mounted device). If a user wants to select a target image from the target video 602, the user may perform a video viewing operation on the target video 602. The video viewing operation may include a trigger operation on the target video 602, a tap operation on a viewing key 603 (or an assembly, a button, an option, or the like), and the like. In this case, in response to the video viewing operation, a terminal device displays, in a form of thumbnails, a plurality of video frames (namely, images) included in the target video. In this way, the user may select, from the plurality of video frames, at least one frame of target image including a face. Further, in response to a confirmation operation for the selected target image (for example, a trigger operation for a confirmation option 604), the image editing interface 605 provided by the application program may be outputted, and the selected at least one frame of target image including the face (where the face included in the image is not masked or has been masked) is displayed on the image editing interface.

FIG. 6 is described by using an example in which one or more video frames are selected from the target video as the target image. In some embodiments, selecting, as the target image on which face masking is to be performed, all the video frames included in the entire target video is further supported. In this case, the image editing interface supports displaying, in a video playing manner, the target video on which face masking is performed, in other words, face masking is performed on all video frames including the face in the target video played on the image editing interface, to implement batch face masking, thereby improving a speed and efficiency of face masking. In addition, after face masking is performed on an image obtained in real time, outputting the image through the image editing interface is further supported in some embodiments. For example, the image obtained in real time may be captured in real time by a vehicle-mounted device deployed in a vehicle. In this case, for a vehicle owner, all images played by a terminal device held by the vehicle owner are all masked images. If the vehicle owner needs to view an unmasked image, the vehicle owner needs to locally view the image from the vehicle. In addition, in some embodiments, the image obtaining interface and the image editing interface mentioned above may be a same interface. For example, in a training-data return scenario, the image obtaining interface and the image editing interface may be a same interface (where the image editing interface is used as an example), and any image displayed on the image editing interface is used as a training image on which face masking needs to be performed, and the foregoing described operation related to image selection does not need to be performed.

S503: Display, at the target face part, a target blocking object blocking the target face part, the face on which the target face part is blocked maintaining the face appearance attribute.

After obtaining the face (the target image including the face) on which face masking is to be performed, the computer device may invoke a face detection network and a face conversion network that are trained, and perform face masking on the target image on which face masking is to be performed, to obtain a masked face; and output the masked face on the image editing interface. The masked face is obtained by blocking the target face part on the face by using the target blocking object.

The target blocking object mentioned above is a blocking object matching the target face part on the face. For example, if the target face part is an oronasal part, the target blocking object for blocking the oronasal part may be a face mask. In some embodiments, if the target face part is an eye part, the target blocking object for blocking the eye part may be glasses or sunglasses. In some embodiments, if the target face part is a hair part, the target blocking object for blocking the hair part may be a fake hair style, a hat, or the like.

According to embodiments, the display, at the target face part, a target blocking object blocking the target face part includes: displaying, at at least one target face part, one target blocking object blocking the at least one target face part.

In some embodiments, one blocking object may correspond to one or more face parts on the face, and different blocking objects correspond to a same face part or different face parts. For example, a blocking object “face mask” corresponds to two face parts: “a mouth part and a nose part”, and a blocking object “glasses” may correspond to one face part “eyes”. A specific style of the target blocking object is not limited herein. For ease of description, an example in which the target blocking object is a face mask and a target blocked part is an oronasal part is used for subsequent description. Details are described herein.

In some embodiments, the face blocked by the target blocking object maintains the face appearance attribute of the original face. The face appearance attribute may include an appearance attribute that can be configured for describing a user face, such as a head orientation, a line of sight, an expression, wearing, and a gender. In other words, in comparison with the original face (for example, the face on which the target face part is not blocked by the target blocking object), the target blocking object is only added to the target face part on the face on which the target face part is blocked by the target blocking object, and an appearance of the face is not affected.

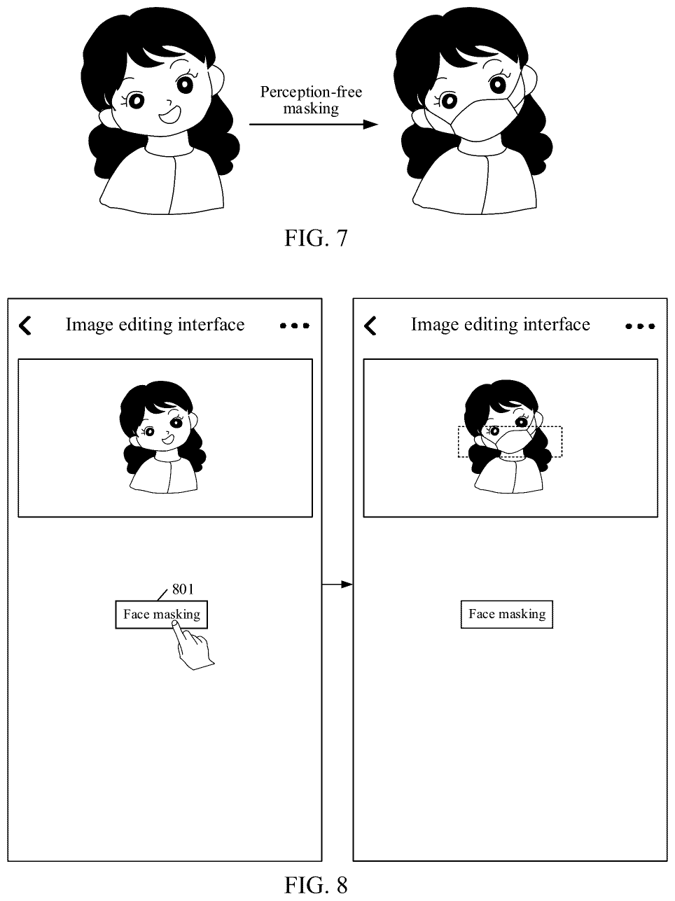

FIG. 7 is a schematic diagram of a face on which a nose part and a mouth part on the face are blocked by a face mask when a target blocking object is the face mask according to some embodiments. As shown in FIG. 7, it can be learned that the face masked by using the face mask maintains a face appearance attribute of the original face, for example, maintains an inclined head orientation, a hair style on a head, and a line of sight of eyes. In this face masking manner of maintaining the face appearance attribute of the face, when sensitive information of the face is eliminated, a face masking trace is basically not generated, so that the user cannot see the masking trace from the masked face, and harmony, aesthetics, and naturalness of the face are maintained. Therefore, when the friendly and natural masked face is applied to a target application scenario, image use efficiency in the scenario is ensured. For example, returning and use of image data or development of a masked downstream applications is facilitated.

In some embodiments, the operation of displaying, at the target face part, a target blocking object blocking the target face part is triggered in response to a blocking trigger operation for the face. The blocking trigger operation includes at least one of a trigger operation for a part removal option on the image editing interface, a gesture operation performed on the image editing interface, a speech-signal input operation on the image editing interface, or an operation of determining, through silent detection by an application program, that the target image includes a face.

In some embodiments, only when the blocking trigger operation for the face on the image editing interface is received, the operation of blocking the target face part on the face by using the target blocking object is triggered to be performed. The blocking trigger operation may include, but is not limited to, any one of the following: the trigger operation for the part removal option on the image editing interface, the gesture operation performed on the image editing interface, the speech-signal input operation on the image editing interface, a silent detection operation performed by the application program in which the image processing method is integrated on the face in the received target image (for example, the received target image is not displayed on the image editing interface before the target image is masked), or the like.

The blocking trigger operation for triggering face masking is not limited herein. An implementation process of implementing face masking based on the blocking trigger operation is described below by using the foregoing several blocking trigger operations as an example with reference to the accompanying drawings.

(1) The blocking trigger operation is the trigger operation for the part removal option on the image editing interface.

As shown in FIG. 8, the image editing interface includes a part removal option 801. A tap operation for the part removal option 801 indicates that the user wants to remove the target face part from the face included in the target image displayed on the icon editing interface. In this case, the target face part may be a default face part in a plurality of face parts included in the face. For example, a target blocking object “face mask” is used by default to block a default to-be-blocked target face part, “oronasal part”, on the face.

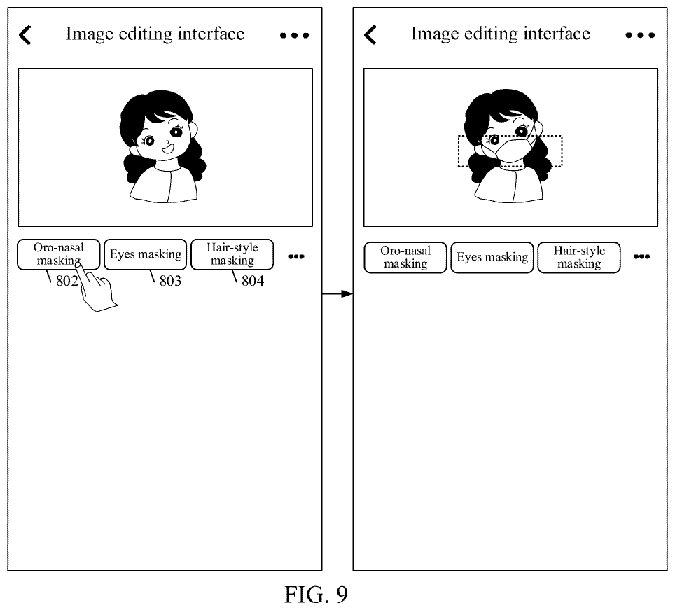

In some embodiments, the image editing interface includes part removal options corresponding to different face parts, for example, an oronasal removal (masking) option 802, an eyes removal (masking) option 803, and a hair style removal (masking) option 804. As shown in FIG. 9, the user may autonomously select at least one part removal option from the plurality of part removal options based on a masking requirement of the user. In this case, in response to a selection operation for the at least one part removal option, a blocking object matching a face part corresponding to the selected at least one part removal option is used on the image editing interface to block the corresponding face part on the face, so as to obtain a masked face. This manner of supporting the user in selecting, in a customized manner, the face part that the user wants to remove from the face elevates selection permission of the user for face masking, satisfies requirements of different users on face masking, and improves user experience and stickiness.

The display location and the display style of the part removal option on the image editing interface may change adaptively based on different interface styles and interface content of the image editing interface. This is not limited herein.

(2) The blocking trigger operation is the gesture operation performed on the image editing interface.

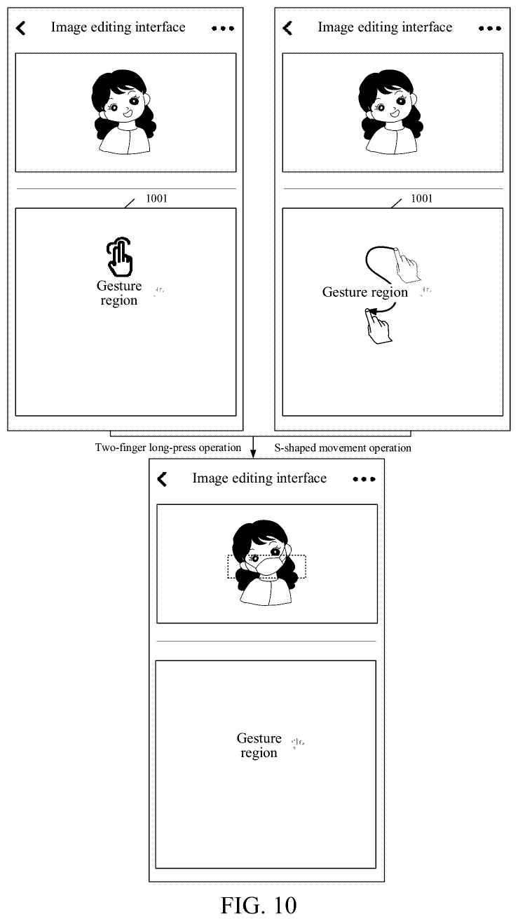

The gesture operation on the image editing interface may include, but is not limited to, a double-tap operation, a long-press operation, a three-finger operation, an operation of sliding by a preset track (such as an “S”-shaped track or an “L”-shaped track), or the like. As shown in FIG. 10, if the gesture operation for triggering face masking is a two-finger long-press operation, when duration for which a display location (for example, a gesture region 1001 on the image editing interface or any display location on the entire image editing interface) on the image editing interface is triggered by two fingers exceeds a duration threshold (for example, 5 seconds), it is determined that the two-finger long-press operation exists on the image editing interface, indicating that the user wants to perform face masking on the face on the image editing interface. In this case, the computer device performs face masking on the face on the image editing interface, and updates and displays the masked face on the image editing interface. Similarly, if the gesture operation for triggering face masking is a movement operation of sliding by a preset “S”-shaped track, when the movement operation of the “S”-shaped track is detected on the image editing interface, it indicates that the user wants to perform face masking on the face on the image editing interface. In this case, the computer device performs face masking on the face on the image editing interface. That is, the target face part on the face is blocked by the target blocking object, and the masked face is updated and displayed on the image editing interface.

In addition, that one gesture operation corresponds to one blocking object is further supported in some embodiments. In this way, when the user performs a target gesture operation (such as any gesture operation) on the image editing interface, the computer device blocks, by using a blocking object corresponding to the target gesture operation and based on a type of the target gesture operation, a face part matching the blocking object, to implement face masking. For example, when the gesture operation is the operation of sliding by the preset “S”-shaped track, a corresponding blocking object is sunglasses. In this case, when the gesture operation is detected on the image editing interface, eyes of the face on the image editing interface are blocked by the blocking object “sunglasses” by default, so that a user identity cannot be recognized based on the face on which the eyes are blocked. For example, when the gesture operation is a double-tap operation, a corresponding blocking object is a face mask. In this case, when the gesture operation is detected on the image editing interface, an oronasal part of the face on the image editing interface is blocked by the blocking object “face mask” by default, so that a user identity cannot be recognized based on the face on which the oronasal part is blocked.

(3) The blocking trigger operation is the speech-signal input operation on the image editing interface.

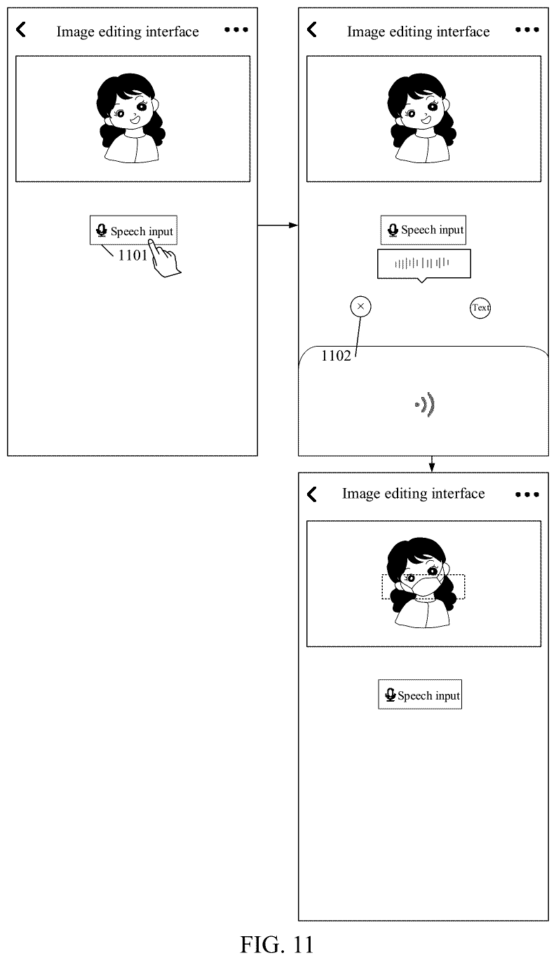

In some embodiments in which the computer device displays the image editing interface, audio in a physical environment in which the user is located may be obtained by using a microphone deployed in the computer device, and a speech signal in the obtained audio is analyzed. If the speech signal indicates that face masking needs to be triggered, the computer device performs face masking on the face on the image editing interface, and displays the masked face on the image editing interface. FIG. 11 is an schematic diagram of an operation of inputting a speech signal on the image editing interface according to some embodiments. As shown in FIG. 11, the image editing interface includes a speech input option 1101. When the speech input option 1101 is triggered, the microphone deployed in the computer device is turned on, and the audio in the physical environment in which the user is located is obtained by using the microphone. In some embodiments, in a process of displaying the image editing interface, the microphone deployed in the computer device is always turned on, to collect, in real time, the audio in the physical environment in which the user is located.

Further, after automatically detecting that the collection of the audio in the physical environment is completed, the computer device may perform an operation such as speech-signal analysis, to determine whether face masking needs to be performed on the face on the image editing interface. Certainly, in addition to automatically detecting, by the computer device, whether to end input of the speech signal, in some embodiments, when a trigger operation for an end option 1102 is detected, it indicates that the user has completed inputting the speech signal, and a terminal performs a subsequent operation such as analyzing the speech signal.

(4) The blocking trigger operation is the operation of determining, through silent detection by the application program, that the received target image includes a face. In other words, after obtaining the target image, the computer device (the application program deployed in the computer device) may directly perform face detection on the target image, and when detecting a face in the target image, determine that a masking condition for the face in the target image is triggered.

In some embodiments, when the computer device triggers display of the image editing interface, the computer device (the application program deployed in the computer device) may automatically and silently perform face detection on the image editing interface, and automatically perform face masking after a face is detected. The user does not need to perform any operation to trigger face masking. This manner in which the application program automatically performs silent face detection and masking does not need a user operation, reduces user workload, and improves intelligence and automation of face masking.

After receiving the target image, the computer device renders the target image and displays the target image on a display screen of the computer device. Therefore, after receiving the target image that is to be rendered and displayed, the computer device may perform face detection and masking on the target image, and directly display the masked target image on the image editing interface, instead of the foregoing related operation in which the unmasked face is first displayed on the image editing interface and then the computer device performs face detection and masking. After receiving the target image that is to be rendered and displayed, the computer device directly performs face masking on the target image, so that a speed and efficiency of face masking are improved to a certain extent.

In some embodiments, the image processing method further includes: outputting blocking prompt information in response to a blocking trigger operation for the face, the blocking prompt information being configured for indicating to block the target face part on the face; and triggering, in response to a confirmation operation for the blocking prompt information, the operation of displaying, at the target face part, a target blocking object blocking the target face part.

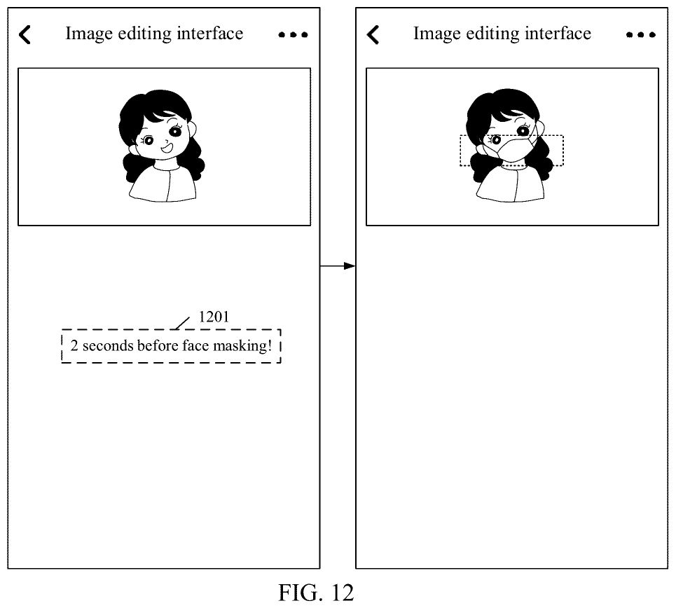

It can be learned from the foregoing descriptions that, when the blocking trigger operation is the silent detection operation performed by the application program for the face on the image editing interface, the user cannot perceive a process of triggering face masking. To improve perception of the user for triggering face masking, in some embodiments, after the application program performs the silent detection operation and detects the face on the image editing interface, the user is prompted that the face is detected and face masking is to be performed, so that the user intuitively perceives masking processing for the face. In some embodiments, as shown in FIG. 12, output of masking prompt information 1201 is supported. The masking prompt information 1201 is configured for prompting that the face is detected and face masking is to be performed. The masking prompt information 1201 may be displayed on the image editing interface for a target time period (for example, 2 seconds), so that the user has sufficient duration to understand content of the masking prompt information 1201.

In some embodiments, the blocking prompt information is displayed in a prompt window, and the prompt window further includes a target face part identifier of the target face part and a part refresh assembly. The image processing method may further includes: when the part refresh assembly is triggered, displaying, in the prompt window, a candidate face part identifier of a candidate face part on the face, the candidate face part being different from the target face part; and displaying, at the candidate face part in response to a confirmation operation for the candidate face part identifier, a target blocking object blocking the candidate face part, the face on which the candidate face part is blocked maintaining the face appearance attribute.

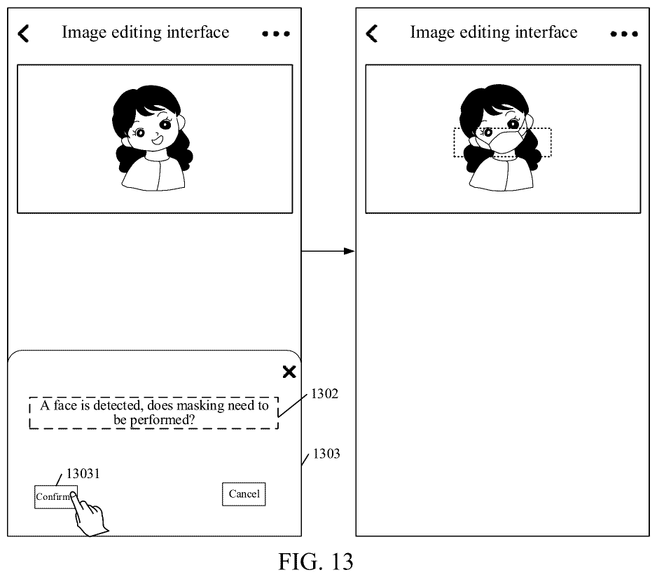

In some embodiments, as shown in FIG. 13, output of blocking prompt information 1302 is further supported. The blocking prompt information 1302 is configured for indicating to block the target face part on the face. In this case, the operation of blocking the target face part on the face by using the target blocking object is triggered in response to a confirmation operation for the blocking prompt information 1302 (for example, a confirmation assembly 13031 included in a prompt window 1303 in which the blocking prompt information 1302 is located is triggered).

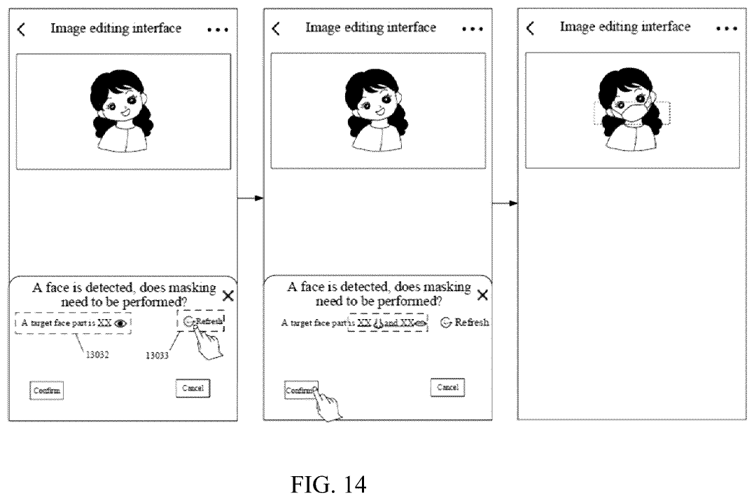

Further, that the user autonomously selects, in the window 1303, a face part that needs to be blocked is further supported in some embodiments, to satisfy masking requirements of the user on different face parts. As shown in FIG. 14, the blocking prompt information 1302 is displayed in the prompt window 1303. In this case, the prompt window 1303 further includes a target face part identifier 13032 (for example, a flag that may be used for uniquely identifying the face part, such as an icon or a text) of the target face part and a part refresh assembly 13033. When the part refresh assembly 13033 is triggered, it indicates that the user wants to replace the to-be-masked face part. In this case, the candidate face part identifier of the candidate face part other than the target face part on the face is outputted in the prompt window 1303. For example, a location at which the target face part is originally displayed in the prompt window 1303 is updated and the candidate face part identifier of the candidate face part is displayed at the location. For example, the target face part is an eye part, and the candidate face part includes a nose part and a mouth part. The computer device blocks, in response to the confirmation operation for the candidate face part identifier, the reference face part by using a blocking object corresponding to the candidate face part corresponding to the selected candidate face part identifier, to implement face masking. Certainly, a face part identifier of another face part other than the target face part on the face is further directly outputted in the prompt window 1303 for the user to select. For example, face part identifiers of a plurality of face parts may be selected. In this case, matching blocking objects may be determined based on the selected face part identifiers of the plurality of face parts. A specific implementation process of selecting the face part identifier in the prompt window 1303 is not limited herein.

The foregoing implementations (1) to (4) are merely some example blocking trigger operations according to some embodiments. In some embodiments, the blocking trigger operation existing on the image editing interface may change. For example, the blocking trigger operation may further include an operation of inputting a shortcut key by using a physical input device (for example, a physical keyboard) or a virtual input apparatus (for example, a virtual keyboard). A specific implementation process of the blocking trigger operation for triggering face masking is not limited herein.

As shown in FIG. 9, a process in which the user selects the to-be-blocked face part on the image editing interface may also be applied to a process in which the blocking trigger operation is a speech input operation.

In some embodiments, the user autonomously selects the blocking object, to enrich a face masking selection permission of the user. In some embodiments, directly selecting a blocking object to determine a to-be-blocked face part based on the selected blocking object is supported. Similar to FIG. 8, the icon editing interface may include object identifiers of a plurality of candidate blocking objects (for example, a flag for uniquely identifying the blocking object). In this way, the user may select an identifier from the object identifiers of the plurality of candidate blocking objects, to determine, as a to-be-blocked face part, a face part corresponding to the selected object identifier.

In some embodiments, the image processing method further includes: displaying an object selection interface, the object selection interface including one or more candidate blocking objects corresponding to the target face part, and different candidate blocking objects having different object styles; and determining, as the target blocking object in response to an object selection operation, a candidate blocking object selected from the one or more candidate blocking objects.

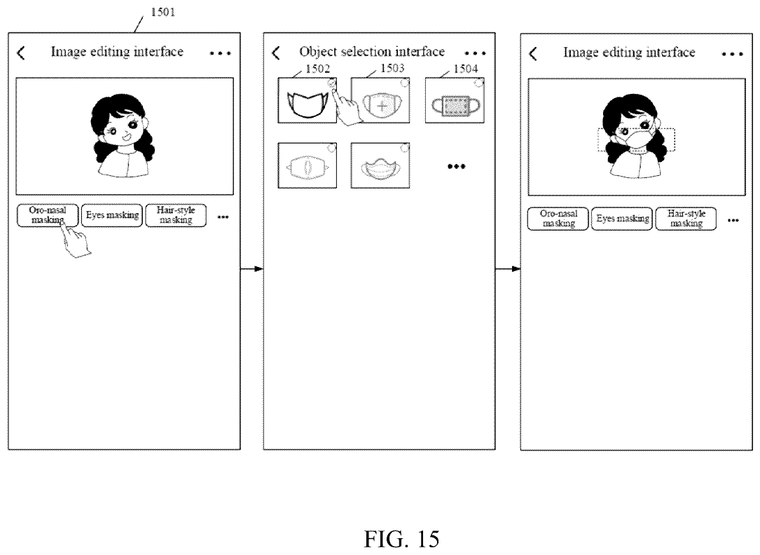

In some embodiments, autonomously selecting, on the basis of that the to-be-blocked face part is determined, an object style of the blocking object matching the face part is supported, to satisfy a customization requirement of the user on the object style of the target blocking object, and improve user experience. As shown in FIG. 15, after the blocking trigger operation is performed and the to-be-blocked target face part (which is, for example, default or autonomously selected by the user) is determined on the image editing interface, output of an object selection interface 1501 is supported. The object selection interface 1501 includes one or more candidate blocking objects, for example, a candidate blocking object 1502, a candidate blocking object 1503, and a candidate blocking object 1504, corresponding to the target face part. Object styles of the candidate blocking objects are different. The user may perform the object selection operation on the object selection interface 1501. In this case, the computer device may select the target blocking object of a target blocking style from the one or more candidate blocking objects in response to the object selection operation. Therefore, the target face part on the face is blocked by the target blocking object of the target blocking style, to obtain the masked face. The one or more candidate blocking objects may be directly displayed on the image editing interface instead of being displayed on the independent object selection interface. A specific display location of the one or more candidate blocking objects is not limited herein.

In some embodiments, the face is displayed on the image editing interface. When the user requires face masking, automatically blocking the target face part (such as a nose part and a mouth part) on the face by using the target blocking object is supported, to implement face masking. In the foregoing solution, when the target face part on the face is blocked by the target blocking object, the target blocking object can adapt to a face posture and flexibly block the target face part on the face. Therefore, the blocked face can still maintain the face appearance attribute of the original face. For example, a posture of the original face is that a head faces upward. In this case, a shape of the target blocking object can change to adapt to the posture of the face, so that the target blocking object whose shape changes can well match the posture of the face. Therefore, it is ensured that a modification trace is basically not formed on the face when sensitive information (for example, information based on which the face can be recognized, such as facial features) on the face is removed, harmony, aesthetics, and naturalness of the blocked face are maintained, and a perception-free face masking effect is provided for the user.

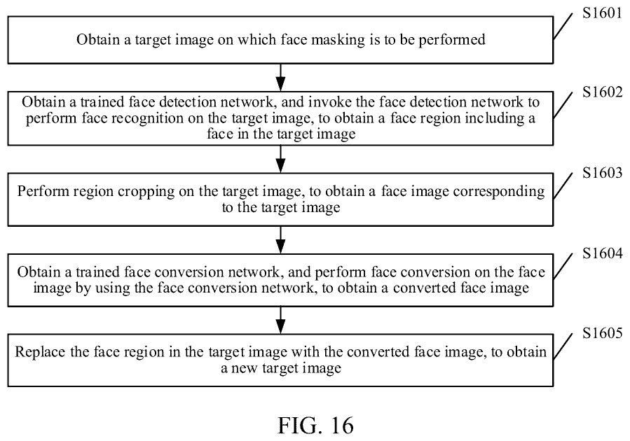

A background technical procedure of the image processing method is described below with reference to FIG. 16. The background technical procedure relates to a process in which the computer device invokes a network or a model to perform face masking on the target image on which face masking is to be performed. FIG. 16 is a schematic flowchart of an image processing method according to some embodiments. The image processing method may be performed by a computer device. The image processing method may include, but is not limited to, operations S1601 to S1605.

S1601: Obtain a target image on which face masking is to be performed, where the target image includes a face.

In some embodiments, when receiving a blocking trigger operation, a computer device determines that face masking needs to be performed. In this case, the target image on which face masking is to be performed may be obtained. As described above, there may be a plurality of blocking trigger operations for triggering face masking. For example, the blocking trigger operation includes a gesture operation on an image editing interface, a trigger operation for a part removal option on the image editing interface, a speech-signal input operation, and the like. In this case, an image that includes the face and that is displayed on the image editing interface may be used as the target image on which face masking is to be performed. For example, the blocking trigger operation includes a silent detection operation of an application program for the face in the target image. In some embodiments, after receiving the target image, the computer device directly performs face detection on the target image (without displaying the unmasked target image on the image editing interface), and determines, when the face is detected, that the target image on which face masking is to be performed is obtained. Further, the obtained target image may be an image autonomously uploaded by a user, an image (which is also referred to as a vehicle-mounted image) captured in real time by a vehicle-mounted device deployed in a vehicle, or the like. A specific source of the target image is not limited herein.

S1602: Obtain a trained face detection network, and invoke the face detection network to perform face recognition on the target image, to obtain a face region including the face in the target image.

S1603: Perform region cropping on the target image, to obtain a face image corresponding to the target image, the face image including the face in the target image.

In operations S1602 and S1603, after the target image on which face masking is to be performed is obtained according to the foregoing operations, in some embodiments, face detection and masking (which is also referred to as conversion) on the target image is implemented by using a model or a network, to implement masking processing on the face in the target image. The trained network is used to detect and convert the face in the target image, and the user does not need to perform a cumbersome operation. For the user, difficulty of face detection and conversion is reduced. In addition, the trained network is trained by using a large amount of training data, so that accuracy of face detection and conversion is ensured.

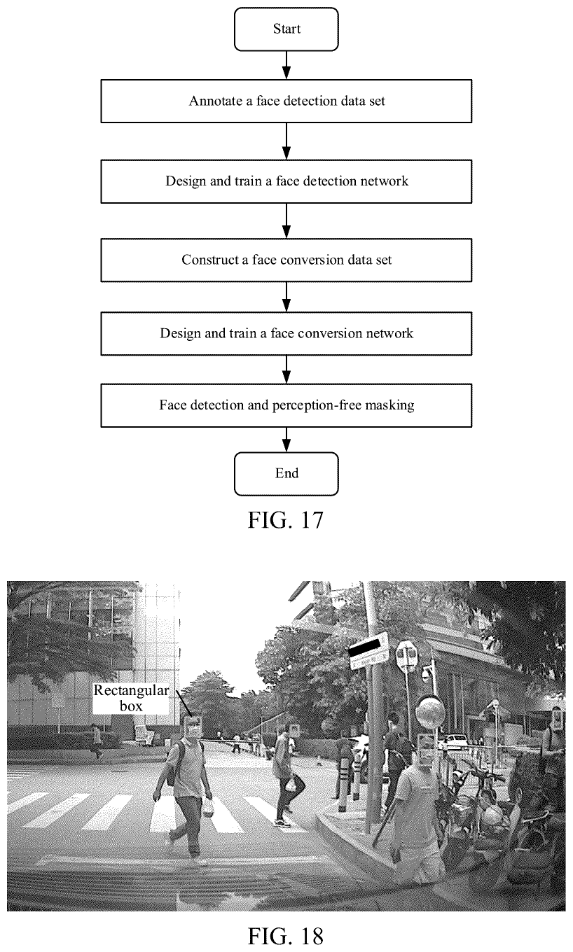

The network in some embodiments may include the face detection network and a face conversion network. The face detection network is configured to detect a region in which the face is located in the target image, and the face conversion network converts the face detected from the target image to block a target face part on the face by using a target blocking object, thereby implementing face masking. For an example process of training the face detection network and the face conversion network and implementing face masking on the target image by using the face detection network and the face conversion network that are trained, refer to FIG. 17. For ease of description, only network training and application of the face detection network are described in operations S1602 and S1603, and network training and application of the face conversion network are described in subsequent operations S1604 and S1605.

In some embodiments, after obtaining the target image on which face masking is to be performed, the computer device supports invoking the trained face detection network to perform multi-scale feature extraction on the target image, obtaining feature maps of different scales (to be specific, a height h and a width w of the feature map), and determining, based on the feature maps, the region in which the face included in the target image is located, to accurately locate the region in which the face is located in the target image. A network training process of the face detection network is described below. The training process of the face detection network may roughly include two operations of constructing a face detection data set and designing and training the face detection network. The two operations may be further subdivided, but are not limited to, operations s11 to s14.

s11: Obtain a face detection data set.

The face detection data set includes at least one sample image and face annotation information corresponding to each sample image. J When a target application scenario is a vehicle-mounted scenario, the sample image may be captured by using a vehicle-mounted device (for example, a driving recorder) deployed in a vehicle. A source of the sample image is not limited to the vehicle-mounted device. @Face annotation information corresponding to any sample image is configured for annotating a region in which a face is located in the corresponding sample image. For ease of understanding, the face annotation information may be represented in a form of a rectangular box. As shown in FIG. 18, in a sample image, all faces included in the sample image may be annotated by using rectangular boxes, and one rectangular box is for annotating one face. However, when the face annotation information is recorded in the background, the face annotation information is recorded in a form of a data structure.

s12: Select an i^{th} sample image from the face detection data set, and perform multi-scale feature processing on the i^{th} sample image by using the face detection network, to obtain feature maps of different scales and face prediction information corresponding to each feature map.

After the face detection data set for training the face detection network is obtained through annotation in operation s11, performing network training on the face detection network based on the face detection data set is supported. In some embodiments, a plurality of rounds of iterative training are performed on the face detection network by using the sample images in the face detection data set until the trained face detection network is obtained. A process of one round of network training is described by using an example in which the i^{th} sample image in the face detection data set is selected, where i is a positive integer. In some embodiments, performing multi-scale feature processing on the i^{th} sample image by using the face detection network is supported, to obtain the feature maps of different scales and the face prediction information corresponding to each feature map. In some embodiments, multi-scale feature processing may include: first performing multi-scale feature extraction on the i^{th} sample image, to obtain the feature maps of different scales; then, to enable the face detection network to better adapt to a scale change of a face in the sample image, supporting performing feature fusion on the feature maps of different scales; and generating a corresponding output feature at each scale. An output feature at any scale includes a feature map corresponding to the scale and face prediction information corresponding to the feature map. The face prediction information corresponding to the feature map may be configured for indicating a region in which the face is located and that is obtained through prediction in the corresponding feature map. That is, the region in which the face is located in the sample image is predicted by using the face detection network.

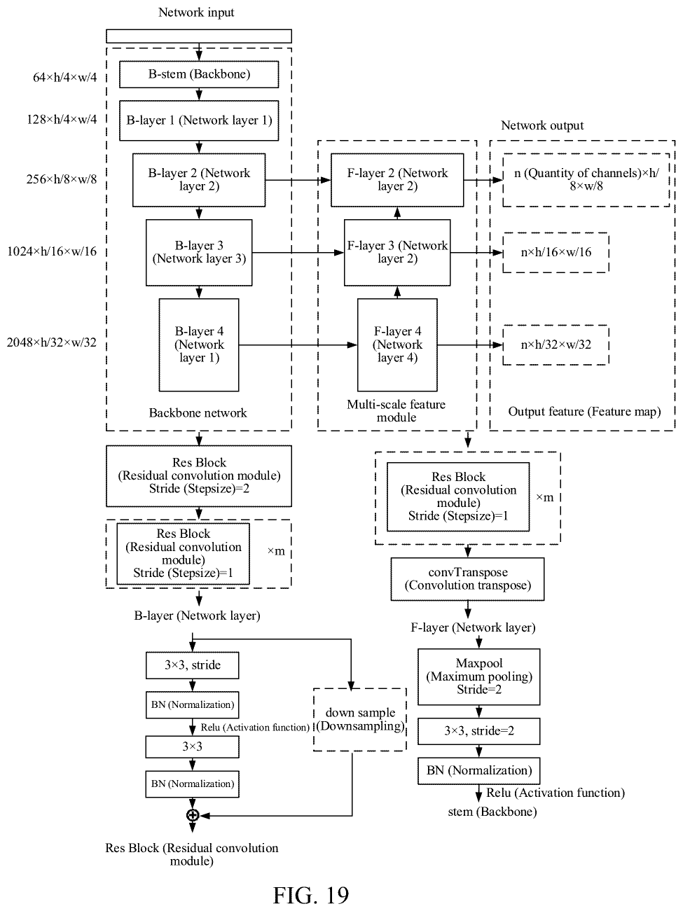

Performing face detection by using the face detection network according to some embodiments is described below with reference to a network structure of the face detection network shown in FIG. 19. As shown in FIG. 19, the face detection network designed in some embodiments roughly includes a backbone network and a multi-scale feature module. Structures and functions of the backbone network and the multi-scale feature module are respectively described below.

(1) The backbone network is mainly configured to perform multi-scale feature extraction on the i^{th} sample image inputted into the face detection network, to extract rich image information of the i^{th} sample image, which is conducive to accurate prediction of the face included in the i^{th} sample image. The backbone network includes one backbone stem and a plurality of network layers B-layers. \textcircled{1} For a structure of the backbone stem, still refer to FIG. 19. The backbone stem includes a maximum pooling layer (Maxpool), a convolutional layer, normalization (BN), and an activation function (Relu). A specific implementation process of performing multi-scale feature extraction on the i^{th} sample image based on the backbone stem included in the backbone network may include: After obtaining the i^{th} sample image, the face detection network first performs pooling processing on the i^{th} sample image by using the maximum pooling layer included in the backbone stem; performs feature extraction on a pooled feature by using the convolutional layer (for example, a convolutional layer whose convolution kernel is 3×3 and whose stepsize stride is 2); and then performs normalization and activation processing on an extracted feature, to obtain feature information extracted by the backbone stem from the i^{th} sample image.

\textcircled{2} Further, the plurality of network layers B-layers included in the backbone network that are of downsampling scales (which are also referred to as scales for short) may be configured to continue to perform feature extraction of different learning scales on the feature information extracted by the backbone stem, to obtain feature information of different scales, so that the rich image information of the i^{th} sample image is extracted. In some embodiments, the network layers B-layers included in the backbone network are respectively: a B-layer 1→a B-layer 2→a B-layer 3→a B-layer 4. For example, a downsampling scale of each network layer B-layer is twice a downsampling scale of a previous network layer B-layer connected to the network layer. Feature extraction is performed on the i^{th} sample image by using the network layers B-layers of different learning scales, so that rich image information included in the i^{th} sample image can be extracted, thereby improving accuracy of detecting the region in which the face is located in the i^{th} sample image.

Each network layer B-layer includes a plurality of residual convolution modules Res Blocks. As shown in FIG. 19, one residual convolution module Res Block is connected in series with m residual convolution modules Res Blocks at one network layer B-layer, and the network layer B-layer includes the residual convolution module Res Block and the m residual convolution modules Res Blocks that are in parallel. Each residual block Resblock is configured to perform convolution calculation on the inputted feature information, to implement a plurality of times of convolution calculation on the image, so as to extract rich feature information (for example, a gray-scale value of each pixel) of the i^{th} sample image. A specific value of m is related to a downsampling scale of the network layer B-layer, and is not limited. Further, for a structure of a single residual convolution module Resblock, refer to FIG. 19. The residual convolution module Resblock may include a plurality of convolution kernels with different learning feature scales or a same learning feature scale (for example, the residual convolution module Resblock in FIG. 19 includes a 3×3 convolution kernel, a normalization module, a 3×3 convolution kernel, and a 1×1 convolution kernel that are connected in series) and a downsampling module. Each convolution kernel is configured to perform, on the inputted feature information, feature extraction of a corresponding learning feature scale (such as 3×3). A specific downsampling scale of the downsampling module included in the residual convolution module Resblock is related to a learning scale of the network layer B-layer to which the residual convolution module Resblock belongs. For example, feature extraction of the convolution kernel and downsampling processing of the downsampling module are separately performed on the feature information inputted into the residual convolution module Resblock, and feature information obtained through feature extraction is fused with feature information obtained through downsampling, to obtain feature information extracted by the residual convolution module Resblock.

In conclusion, multi-scale feature extraction is performed on the i^{th} sample image by using the foregoing described backbone network including the plurality of downsampling scales, so that the feature information (which is also referred to as a feature map) of different scales that corresponds to the i^{th} sample image can be extracted, to obtain the rich information of the i^{th} sample image.

(2) The multi-scale feature module is mainly configured to perform feature fusion (which is also referred to as feature enhancement) on the plurality of pieces of feature information that are of different scales and that are outputted by the backbone network, to generate a corresponding feature map at each scale. The feature information of different scales is fused, to help the face detection network better learn and adapt to a size change of the face in the sample image. For example, scales of rectangular boxes for annotating faces in different sample images may be different. For example, scales of rectangular boxes for annotating different faces in a same sample image may also be different. As shown in FIG. 19, the multi-scale feature module includes a plurality of network layers F-layers. Each network layer F-layer has a downsampling scale the same as that of a network layer B-layer included in a previous stage (namely, the backbone network), and is configured to receive feature information outputted by the same network layer B-layer included in the previous stage, to perform feature enhancement on the feature information. In some embodiments, to enable the face detection network to adapt to the size change of the face in the sample image, generating corresponding feature information by using the corresponding network layer F-layer after the feature information that is of different scales and that is outputted in the previous stage are fused is supported.

As shown in FIG. 19, in some embodiments, the network layers F-layers included in the multi-scale feature module are respectively: a F-layer 2→a F-layer 3→a F-layer 4. As shown in FIG. 19, a plurality of residual convolution modules Resblocks are arranged in parallel and are connected in series with one convolution transpose module convTranspose at each network layer F-layer, and the network layer F-layer includes the plurality of residual convolution modules Resblocks and the convolution transpose module convTranspose. For related content of the convolution module Resblock, refer to the foregoing related descriptions, and details are not described herein. The convolution transpose module convTranspose is also referred to as deconvolution, and is an upsampling manner. Similar to a principle of convolution, a learnable parameter is included, and an optimal upsampling manner may be obtained through network learning, to implement upsampling processing on the feature information. In some embodiments, performing feature fusion based on the plurality of network layers F-layers included in the multi-scale feature module may include: The network layer F-layer 4 receives feature information outputted by the network layer B-layer 4 in the backbone network, and performs feature enhancement on the feature information, to generate feature information of a corresponding scale. For example, a scale of a generated feature map is n×h/32×w/32. Then, the network layer F-layer 3 receives feature information outputted by the network layer B-layer 3 in the backbone network and the feature information outputted by the network layer F-layer 4, and generates, based on fused feature information after fusing the two pieces of feature information, feature information at a scale indicated by the network layer F-layer 3. For example, a scale of a generated feature map is n×h/16×w/16. Similarly, the network layer F-layer 2 receives feature information outputted by the network layer B-layer 2 in the backbone network and the feature information outputted by the network layer F-layer 3, and generates, based on fused feature information after fusing the two pieces of feature information, feature information at a scale indicated by the network layer F-layer 2. For example, a scale of the generated feature map is n×h/8×w/8.

The parameter n in the scale of each feature map outputted by the network represents a quantity of channels of the feature map. Each channel of the feature map corresponds to specific information configured for representing the i^{th} sample image. The quantity n of channels of the feature map may be represented as n=b×(4+1+c). b is a quantity of anchor boxes (namely, the foregoing described rectangular boxes) at each location on the feature map. 4 represents an offset regressor of a center horizontal coordinate, a center vertical coordinate, a length, and a width of each anchor box. 1 represents a confidence level (namely, confidence, which is represented in a form of a probability) that a location on the feature map is a location (which is also referred to as a location of a target) of a face. c is a quantity of target types, to be specific, a set quantity of types of to-be-recognized objects in the sample image. In some embodiments, the to-be-recognized object is a face. Therefore, a value of c may be 1. It can be learned that the quantity of channels of the feature map may be represented as n=b×(5+c).

Further, a manner of determining the quantity b of anchor boxes at each location on the feature map is as follows: A total quantity of anchor boxes of all sizes is specified as B (for example, B=9). Then, all rectangular boxes are clustered into a class B by using k-means and by using, as a feature, a height and a width of the rectangular box for annotating the face. The k-means algorithm is a clustering algorithm based on a Euclidean distance, where when a distance between two targets are smaller, similarity between the two objects is considered to be higher. When k-means is applied to some embodiments, clustering of all the rectangular boxes is implemented by using the height and the width of the rectangular box as a feature. For example, rectangular boxes with similar heights and widths are considered to have higher similarity, and may be classified into a same class. Further, a class center of the class B is used as a height and a width of a corresponding anchor box, to determine the anchor box of the class B. Finally, the anchor boxes are sorted in ascending order of areas (which are determined based on heights and widths). When there are feature maps of three scales, anchor boxes in the first third of a sorting sequence are used on a feature map with a largest scale, anchor boxes in the middle third of the sorting sequence are used on a feature map with an intermediate scale, and anchor boxes in the last third of the sorting sequence are used on a feature map with a smallest scale. The quantity b of anchor boxes at each location on the feature map is determined based on anchor boxes on each outputted feature map, to obtain face prediction information corresponding to the feature maps of different scales. The face prediction information may be reflected by the parameters involved in the process of determining the quantity of channels and the process of determining the anchor box on the feature map, such as the quantity of anchor boxes on the feature map, the confidence level, and the quantity of target types.

In conclusion, multi-scale feature extraction and feature enhancement can be implemented on the i^{th} sample image by using the backbone network and the multi-scale feature module, to obtain the rich image information in the i^{th} sample image, thereby helping the face detection network better implement face detection in the image and ensuring face detection performance of the face detection network.

s13: Train the face detection network based on the feature maps of different scales, the face prediction information corresponding to each feature map, and the face annotation information corresponding to the i^{th} sample image, to obtain the trained face detection network.

According to the foregoing operation, after multi-scale feature processing is performed on the i^{th} sample image by using the face detection network, the feature maps of different scales and the face prediction information corresponding to each feature map may be obtained. Then, separately performing loss calculation on the feature map at each scale and the corresponding face prediction information by using the face annotation information corresponding to the i^{th} sample image is supported, to obtain loss information corresponding to the scales. In this way, the loss information corresponding to the scales is added, and the face detection network is trained by using an addition result. A loss function for determining loss information corresponding to any scale (where each scale may be considered to correspond to one branch) is the following formula:

$${loss}_{n} = α {\sum }_{i = 0}^{{s}_{n}^{2}} {\sum }_{j = 0}^{{b}_{n}} {ℚ}_{i j}^{obj} [ {( {x}_{i j} - {\hat{x}}_{i j} )}^{2} + {( {y}_{i j} - {\hat{y}}_{i j} )}^{2} ] + α {\sum }_{i = 0}^{{s}_{n}^{2}} {\sum }_{j = 0}^{{b}_{n}} {ℚ}_{i j}^{obj} [ {( {w}_{i j} - {\hat{w}}_{i j} )}^{2} + {( {h}_{i j} - {\hat{h}}_{i j} )}^{2} ] + β {\sum }_{i = 0}^{{s}_{n}^{2}} {\sum }_{j = 0}^{{b}_{n}} {{ℚ}_{i j}^{obj} ( {C}_{i j} - {\hat{C}}_{i j} )}^{2} + γ {\sum }_{i = 0}^{{s}_{n}^{2}} {\sum }_{j = 0}^{{b}_{n}} {{ℚ}_{i j}^{o b j} ( {p}_{i} ( k ) - {\hat{p}}_{i} ( k ) )}^{2} \qquad ( 1 )$$

It can be learned from the formula (1) that the loss function sequentially includes four sub-parts. A first sub-part and a second sub-part are a prediction box obtained by predicting the i^{th} sample image by using the face detection network and an offset regressor loss relative to a center point, a width, and a height of an anchor box. A third sub-part is a class loss, to be specific, a difference between an actual class face in the i^{th} sample image and a predicted class predicted by the face detection network for the i^{th} sample image. A fourth sub-part is whether there is a confidence-level loss of a target, and is determined by calculating a sum of losses of all the classes on the outputted feature map. Sₙ represents a width and a height of the outputted feature map. bₙ is the quantity of anchor boxes at each location on the feature map. [symbol] ᵢⱼ^{obj} represents querying whether a location (i, j) on the outputted feature map is on the target (namely, the face). If the location (i, j) is on the target, a value is 1; otherwise, the value is 0. α, β, γ represent weights lost at the sub-parts.

As shown in FIG. 19, if there are three example scales provided in some embodiments, total loss information of a face detection model may be represented as a sum of loss information of three scale branches, and is shown as follows:

$$loss = {loss}_{1} + {loss}_{2} + {loss}_{3} \qquad ( 2 )$$

After loss information of a current round of network training is obtained through calculation based on the formula (2), optimizing a model parameter of the face detection network by using the loss information is supported, to obtain the trained face detection network.

s14: Re-select an (i+1)^{th} sample image from the face detection data set, and perform iterative training on the trained face detection network by using the (i+1)^{th} sample image until the face detection model tends to be stable.

After the i^{th} sample image is selected from the face detection data set and network training is performed on the face detection network, to obtain the trained face detection network, continuing to train the trained face detection network by using the (i+1)^{th} sample image in the face detection data set until the sample images in the face detection data set are all used for network training or the trained face detection network has good face prediction performance is supported. A specific implementation process of training the face detection network by using the (i+1)^{th} sample image is the same as the specific implementation process of training the face detection network by using the i^{th} sample image. For details, refer to the related descriptions of the process shown in operations s11 to s13, and details are not described herein again.

S1604: Obtain a trained face conversion network, and invoke the face conversion network to perform face conversion on the face image, to obtain a converted face image, the target face part in the converted face image being blocked by the target blocking object.

S1605: Replace the face region in the target image with the converted face image, to obtain a new target image.

In operations S1604 and S1605, after face detection is performed on the target image based on the face detection network trained in the foregoing operations, the region in which the face is located in the target image may be determined. The region in which the face is located is cropped, to obtain the face image including the face. Then, face conversion may be performed on the face image by using the trained face conversion network, where face conversion is implemented as converting the face that is in the face image and that is not blocked by the target blocking object (such as a face mask) into the face on which the target face part is blocked by the target blocking object, to implement face masking. Finally, the face region detected in the target image is replaced with the masked face image, to obtain the new target image, where the new target image is an image on which face masking is performed. After the new target image is obtained, the new target image may be displayed on the image editing interface.

In some embodiments, the face conversion network is implemented by using a generative adversarial network (GAN). The GAN is a deep learning model in artificial intelligence (AI) technologies. The GAN may include at least two networks (which are also referred to as modules): a generator network (generative model) and a discriminator network (discriminative model), and a good output result is generated through game-theoretic learning between the at least two modules. The generator network and the discriminator network that are included in the GAN are briefly introduced by using an example in which a type of input data of the GAN is an image and the GAN has a function of generating an image including a target. The generator network is configured to process one or more frames of inputted images including the target, to generate a new frame of image including the target. The new image is not included in the one or more frames of inputted images. The discriminator network is configured to perform discrimination on a frame of inputted image to determine whether an object included in the image is the target. During training of the GAN, the image generated by the generator network may be provided for the discriminator module for discrimination, and a parameter of the GAN is continuously corrected based on a discrimination result until the trained generator network in the GAN can accurately generate a new image and the discriminator network can accurately perform discrimination on the image.

It can be learned that the face conversion network provided in some embodiments may include the generator network and the discriminator network. Further, in consideration of that two image domains related to some embodiments are respectively an image domain that does not include the target blocking object and an image domain including the target blocking object, the generator network included in the face conversion network may include a first image-domain generator corresponding to a first image domain and a second image-domain generator corresponding to a second image domain. Similarly, the discriminator network included in the face conversion network may include a first image-domain discriminator corresponding to the first image-domain generator and a second image-domain discriminator corresponding to the second image-domain generator. For ease of description, for example, the target blocking object is a face mask. In some embodiments, an image domain in which no face mask is worn is denoted as A, namely, the first image domain, and an image domain in which the face mask is worn is denoted as B, namely, the second image domain. G_{A} is used as the first image-domain generator from the domain B to the domain A, G_{B} is used as the second image-domain generator from the domain A to the domain B, D_{A} is used as the first image-domain discriminator for determining whether an image is real in the domain A, and D_{B} is used as the second image-domain discriminator for determining whether an image is real in the domain B.

During specific implementation, after invoking the trained face detection network to obtain, by performing cropping on the target image, the face image including the face, the computer device may invoke the trained face conversion network (for example, invoke the trained second image-domain generator) to perform conversion on the face image, so that the face mask is worn in the face image. In this way, the face is masked. A network training process of the face conversion network is described below. The training process of the face conversion network may roughly include two operations of constructing a face conversion data set and designing and training the face conversion network. The two operations may be further subdivided, but are not limited to, operations s21 to s24.

s21: Obtain a face conversion data set.

The face conversion data set includes a plurality of first sample face images belonging to a first image domain and a plurality of second sample face images belonging to a second image domain, a target face part in the first sample face image is not blocked, and a target face part in the second sample face image is blocked. For example, a specific implementation of obtaining the face conversion data set may include: cropping the face annotated in the face detection data set, to add the face image that includes the face and that is obtained through cropping to a face image set. Further, to enrich the face conversion data set, capturing more images (such as vehicle-mounted images), detecting and cropping faces in the images by using the trained face detection network, and adding face images obtained through cropping to the face image set, to obtain a new face image set is further supported in some embodiments. Then, the face image set obtained in the foregoing operation is processed. The processing herein may include, but is not limited to, removing a blurred or incomplete face, and removing a false detection result that is not a face. Finally, a remaining face image set that is processed is divided into the first image domain of faces wearing no face mask and the second image domain of faces wearing the face mask.

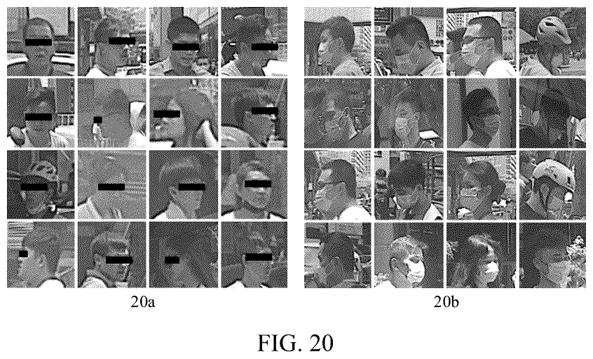

For an example schematic diagram of the plurality of first sample face images in which no face mask is worn and that are included in the first image domain and the plurality of second sample face images in which the face mask is worn and that are included in the second image domain, refer to FIG. 20. A FIG. 20a in FIG. 20 is the plurality of first sample face images in which no face mask is worn, and a FIG. 20b in FIG. 20 is the plurality of second sample face images in which the face mask is worn.

s22: Perform image generation on the second sample face image by using the first image-domain generator, to obtain a first reference face image; and perform image generation on the first sample face image by using the second image-domain generator, to obtain a second reference face image.

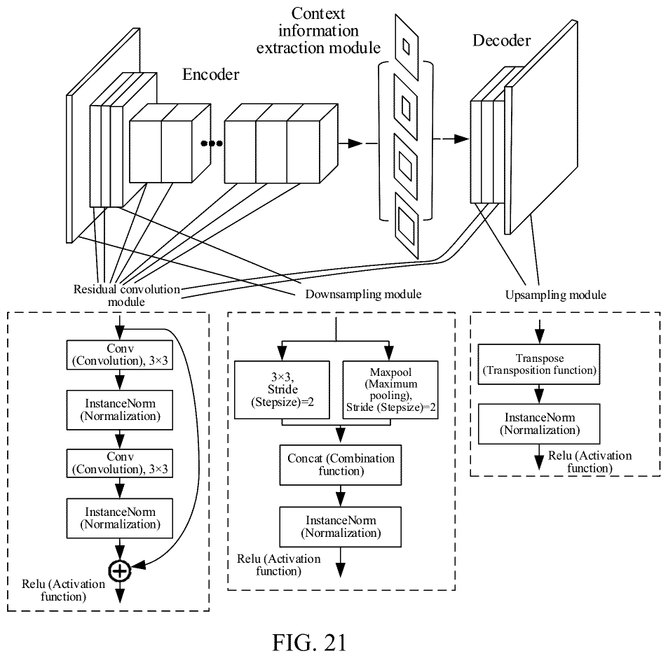

For an example schematic diagram of a network structure of the generator network (such as the first image-domain generator or the second image-domain generator), refer to FIG. 21. As shown in FIG. 21, the generator network includes an encoder, a residual convolution module, a context information extraction module, and a decoder. The encoder performs downsampling and may be referred to as a downsampling module. The decoder performs upsampling and may be referred to as an upsampling module. To avoid detailed information, when downsampling is performed on an inputted sample face image by using the encoder, both a height and a width of a feature map are downsampled to only ¼ of the original values. In consideration of a small downsampling multiple, insufficient extraction of context information in the sample face image is easily caused. Therefore, a dilated convolution pyramid including different expansion rates is used in the generator network, to expand a receptive field of the generator network for the sample face image, so that richer image information of the sample face image is extracted. Finally, a resolution of the feature is restored to a resolution of the inputted sample face image by using the light-weight decoder, to generate a new reference image belonging to an image domain to which the generator network belongs.

It can be learned based on the related descriptions of the generator network that, inputting a red, green, and blue (RGB) image (to be specific, a sample face image including red (R), green (G), and blue (B), where the sample face image is different for different image-domain generators) into the generator network is supported in some embodiments. The generator network performs image generation on the inputted sample face image, to generate a three-channel feature map with a resolution the same as an input resolution. For example, if the generator network is the first image-domain generator, a sample face image inputted into the generator network is the second sample face image in which the face mask is worn. In this case, the first image-domain generator is configured to perform image generation on the second sample face image, to generate the first reference face image corresponding to the second sample face image. A difference between the first reference face image and the second sample face image is that the target face part in the first reference face image is not blocked. Similarly, if the generator network is the second image-domain generator, a sample face image inputted into the generator network is the first sample face image in which no face mask is worn. In this case, the second image-domain generator is configured to perform image generation on the first sample face image, to generate the second reference face image corresponding to the first sample face image. A difference between the second reference face image and the first sample face image is that the target face part in the second reference face image is blocked. It can be learned that both the first image-domain generator and the second image-domain generator are intended to generate a reference face image that belongs to a current image domain based on a sample face image that does not belong to the current image domain, to generate a new image. In this way, when this embodiment is applied to the field of face masking, a target image in which the face mask is worn can be generated based on a target image in which no face mask is worn and by using the second image-domain generator for wearing the face mask, to mask the face in the target image, and achieve an objective of protecting face privacy information.

s23: Perform image discrimination on the first reference face image by using the first image-domain discriminator, and perform image discrimination on the second reference face image by using the second image-domain discriminator, to obtain adversarial generative loss information of the face conversion network.

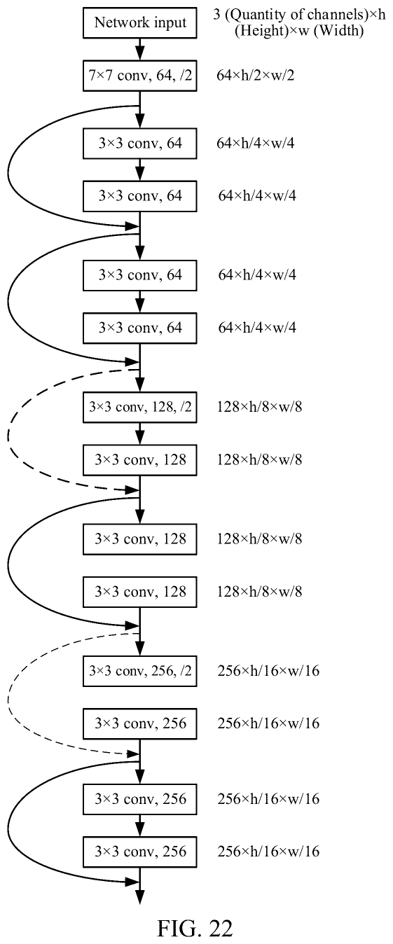

For an example schematic diagram of a network structure of the discriminator network (such as the first image-domain discriminator or the second image-domain discriminator), refer to FIG. 22. As shown in FIG. 22, the discriminator network includes a plurality of convolution modules connected in series. A convolution kernel of a first convolution module may be 7×7, and a convolution kernel of a subsequent convolution module may be 3×3. During specific implementation, an input of the discriminator network includes: a fake image (for example, the first reference face image generated by the first image-domain generator based on the second sample face image, where the first reference face image is not real, and therefore may be referred to as the fake image) outputted by a corresponding generator network, and a real image (where for example, the discriminator network is the first image-domain discriminator, and the real image may be any first sample face image belonging to the first image domain) in an image domain to which the discriminator network belongs. The discriminator network performs a plurality of times of convolution calculation on the inputted fake image and real image, and may output a feature map whose height and width are downsampled to 1/16 of a scale of the inputted images (such as the real image and the fake image), where a quantity of channels of the feature map is 1. Therefore, a possibility (which is represented by, for example, a probability) that the false image inputted into the discriminator network is correct is determined based on the feature map.

Further, adversarial generative loss information L_{GAN} (G_{B}, D_{B}, A, and B) from the first image domain (namely, the domain A) to the second image domain (namely, the domain B) and adversarial generative loss information L_{GAN} (G_{A}, D_{A}, A, and B) from the second image domain (namely, the domain B) to the first image domain (namely, the domain A) may be determined based on the related implementation processes of the generator network and the discriminator network. The adversarial generative loss information L_{GAN}(G_{B}, D_{B}, A, and B) may be represented as:

$${L}_{GAN} ( {G}_{B} , {D}_{B} , A , B ) = {E}_{{B}^{real} ∼ {P}_{data} ( {B}^{real} )} [ log {D}_{B} ( {B}^{real} ) ] + {{E}_{{A}^{real}}}_{∼ {P}_{data} ( {A}^{real} )} [ log ( 1 - {D}_{B} ( {G}_{B} ( {A}^{real} ) ) ) ] \qquad ( 3 )$$

Similarly, the adversarial generative loss information L_{GAN} (G_{A}, D_{A}, A, and B) may be represented as:

$${L}_{GAN} ( {G}_{A} , {D}_{A} , A , B ) = {E}_{{A}^{real} ∼ {P}_{data} ( {A}^{real} )} [ log {D}_{A} ( {A}^{real} ) ] + {E}_{{B}^{real} ∼ {P}_{data} ( {B}^{real} )} [ log ( 1 - {D}_{A} ( {G}_{A} ( {B}^{real} ) ) ) ] \qquad ( 4 )$$

A represents the image domain in which no face mask is worn, namely, the first image domain. B represents the image domain in which the face mask is worn, namely, the second image domain. G_{A} represents the first image-domain generator from the second image domain to the first image domain. G_{B} represents the second image-domain generator from the first image domain to the second image domain. D_{A} represents the first image-domain discriminator for determining whether an image is real in the first image domain. D_{B} represents the second image-domain discriminator for determining whether an image is real in the second image domain.

B^{real} represents the second sample face image that belongs to the second image domain and that is inputted into the first image-domain generator. A^{real} represents the first sample face image that belongs to the first image domain and that is inputted into the second image-domain generator. B^{real}˜P_{data}(B^{real}) represents probability distribution of the plurality of second sample face images belonging to the second image domain. A^{real}˜P_{data}(A^{real}) represents probability distribution of the plurality of first sample face images belonging to the first image domain. E may represent mathematic expectation.

s24: Train the face conversion network based on the adversarial generative loss information, the first reference face image, and the second reference face image.

In consideration of that the generator network generates only fake images with consistent styles, but a semantic of a translated image is expected to remain unchanged in some embodiments, for example, after conversion, an ear is still at an original location of the ear, and a forehead is still at an original location of the forehead, when the second image-domain generator is used to generate a fake image, which is represented as, for example, B^{fake}(namely, the second reference face image), that is, B^{fake} is a fake image that is of the domain B and that is generated from a real image A^{real} belonging to a first domain, B^{fake} is reconstructed by the first image-domain generator as an image A^{rec} in the domain A, to ensure that the face on which face masking is performed maintains a face appearance attribute of the original face. Therefore, the face on which face masking is performed looks more natural, to implement perception-free face masking. Further, the reconstructed image is expected to be the same as the original real image. Therefore, similarity between the original image and the reconstructed image may be calculated to measure a reconstruction loss of the face conversion network.

Based on the related descriptions of an image reconstruction principle, a specific implementation process of training the face conversion network based on the adversarial generative loss information, the first reference face image, and the second reference face image may include: \textcircled{1} Perform image reconstruction on the first reference face image by using the second image-domain generator, to obtain a second reconstructed face image, a target face part in the second reconstructed face image being blocked by a blocking object; and perform image reconstruction on the second reference face image by using the first image-domain generator, to obtain a first reconstructed face image, a target face part in the first reconstructed face image being not blocked. \textcircled{2} Obtain reconstruction loss information of the face conversion network based on similarity between the first reconstructed face image and the corresponding first sample face image and similarity between the second reconstructed face image and the corresponding second sample face image. The similarity between two images (for example, the first reconstructed face image and the corresponding first sample face image, or the second reconstructed face image and the corresponding second sample face image) may be calculated by using an L1 regulation or lasso (L1) norm. The L1 norm is actually a process of solving an optimal solution. In this case, a reconstruction loss of the domain A may be expressed as:

$${L}_{rec}^{A} = {E}_{{A}^{real} ∼ {P}_{data} ( {A}^{real} )} [ {‖ {G}_{A} ( {G}_{B} ( {A}^{real} ) ) - {A}^{real} ‖}_{1} ] \qquad ( 5 )$$

Similarly, a reconstruction loss of the domain B may be represented as:

$${L}_{rec}^{B} = {{E}_{{B}^{real}}}_{∼ {P}_{data} ( {B}^{real} )} [ {‖ {G}_{B} ( {G}_{A} ( B ) ) - {B}^{real} ‖}_{1} ] \qquad ( 6 )$$

\textcircled{3} Train the face conversion network based on the reconstruction loss information and the adversarial generative loss information.

In conclusion, weights are set for the reconstruction loss information and the adversarial generative loss information of the face conversion network, and total loss information of the face conversion network may be obtained as follows:

$$Loss = {L}_{GAN} ( {G}_{B} , {D}_{B} , A , B ) + {L}_{GAN} ( {G}_{A} , {D}_{A} , A , B ) + {L}_{rec}^{A} + {L}_{rec}^{B} \qquad ( 7 )$$

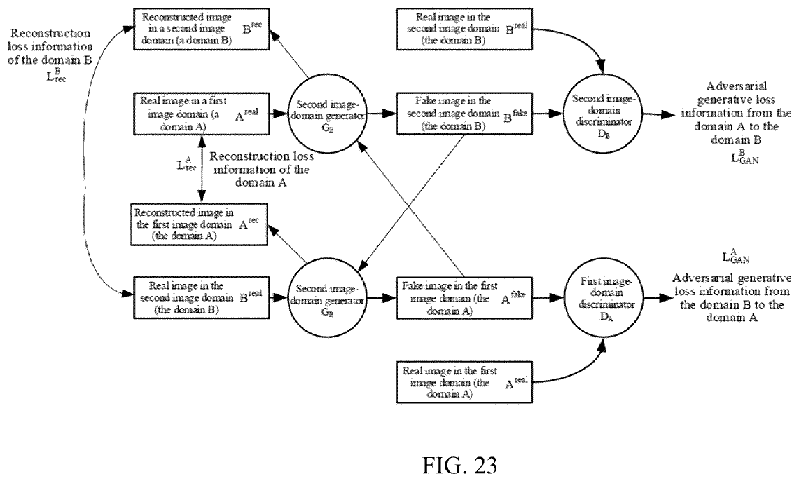

For ease of understanding, a flowchart shown in FIG. 23 is used to represent a specific process of generating each piece of sub loss information included in the total loss information of the face conversion network. A procedure shown in FIG. 23 is similar to the foregoing descriptions, and details are not described herein again.

After the total loss information of the face conversion network is obtained, a model parameter of the face conversion network may be optimized based on the total loss information, to obtain an optimized face conversion network. In a process of optimizing the model parameter of the face conversion network based on the total loss information, training the face conversion network (which is also referred to as a generative adversarial network) based on a minimax zero-sum game is supported in some embodiments. For example, the face conversion network is trained based on a value function G×=argminGmaxDLoss. A training process of training the face conversion network based on the value function may include: A weight of the discriminator network in the formula (7) is first fixed, and then a weight of the generator network is updated in a direction of minimizing the total loss information. Then, the weight of the generator network in the formula (7) is fixed, and then the weight of the discriminator network is updated in a direction of maximizing the total loss information. Finally, the foregoing two operations are alternately performed to implement model training of the face conversion network.

Similar to the training process of the face detection network, after this round of training the face conversion network ends, selecting a new sample face image from the face conversion data set again is supported, to continue to perform iterative training on the face conversion network trained in the previous round, until a face conversion network with stable performance is obtained. For a specific implementation process of continuing to train, by using the new sample face image, the face conversion network trained in the previous round, refer to the related descriptions of the specific implementation process of training the face conversion network by using the sample face image, and details are not described herein again.

In conclusion, in some embodiments, when the target face part on the face is blocked by the target blocking object, the target blocking object can adapt to a face posture and flexibly block the target face part on the face. Therefore, the blocked face can still maintain the face appearance attribute of the original face. For example, a posture of the original face is that a head faces upward. In this case, a shape of the target blocking object can change to adapt to the posture of the face, so that the target blocking object whose shape changes can well match the posture of the face. Therefore, it is ensured that a modification trace is basically not formed on the face when sensitive information (for example, information based on which the face can be recognized, such as facial features) on the face is removed, harmony, aesthetics, and naturalness of the blocked face are maintained, and a perception-free face masking effect is provided for the user.

The method in some embodiments is described in detail above. To facilitate better implementation of the method, correspondingly, the following provides an apparatus according to some embodiments.

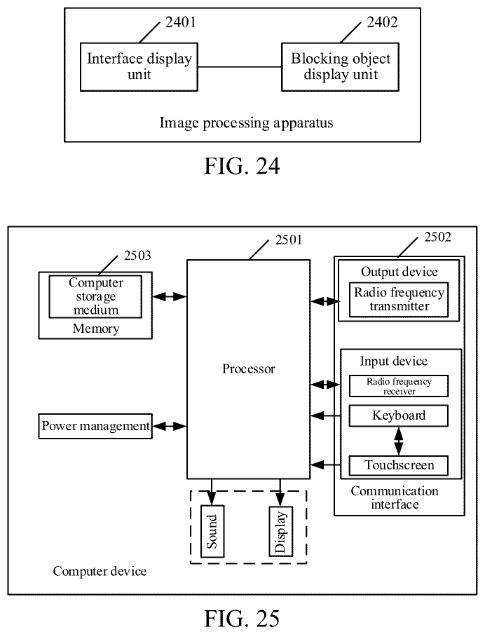

FIG. 24 is a schematic diagram of a structure of an image processing apparatus according to some embodiments. The image processing apparatus may be computer-readable instructions (including program code) running in a computing device. The image processing apparatus may be configured to perform a part or all of the operations in the method embodiments shown in FIG. 5 and FIG. 16. The apparatus includes the following units:
an interface display unit 2401, configured to display an image editing interface; and display a target image on the image editing interface, the target image including a face, the face having a face part, the face part including a to-be-blocked target face part, and the face having a face appearance attribute; and
a blocking object display unit 2402, configured to display, at the target face part, a target blocking object blocking the target face part, the face on which the target face part is blocked maintaining the face appearance attribute.

In some embodiments, the blocking object display unit 2402 is further configured to display, at at least one target face part, one target blocking object blocking the at least one target face part.

In some embodiments, the face appearance attribute includes a head orientation, a line of sight, an expression, wearing, and a gender.

In some embodiments, the blocking object display unit 2402 is further configured to: in response to a blocking trigger operation for the face, trigger displaying, at the target face part, the target blocking object blocking the target face part.

The blocking trigger operation includes at least one of a trigger operation for a part removal option on the image editing interface, a gesture operation performed on the image editing interface, a speech-signal input operation on the image editing interface, or an operation of determining, through silent detection by an application program, that the target image includes a face.

In some embodiments, the blocking object display unit 2402 is further configured to output blocking prompt information in response to a blocking trigger operation for the face, the blocking prompt information being configured for indicating to block the target face part on the face; and display, at the target face part in response to a confirmation operation for the blocking prompt information, the target blocking object blocking the target face part.

In some embodiments, the blocking prompt information is displayed in a prompt window, and the prompt window further includes a target face part identifier of the target face part and a part refresh assembly. The blocking object display unit 2402 is further configured to: when the part refresh assembly is triggered, display, in the prompt window, a candidate face part identifier of a candidate face part on the face, the candidate face part being different from the target face part; and display, at the candidate face part in response to a confirmation operation for the candidate face part identifier, a target blocking object blocking the candidate face part, the face on which the candidate face part is blocked maintaining the face appearance attribute.

In some embodiments, the blocking object display unit 2402 is further configured to display an object selection interface, the object selection interface including one or more candidate blocking objects corresponding to the target face part, and different candidate blocking objects having different object styles; and determine, as the target blocking object in response to an object selection operation, a candidate blocking object selected from the one or more candidate blocking objects.

In some embodiments, the apparatus is applied to a vehicle-mounted scenario. The blocking object display unit 2402 is further configured to display face retention prompt information, the face retention prompt information being configured for indicating whether to back up the face on which the target face part is not blocked; and display retention notification information in response to a confirmation operation for the face retention prompt information, the retention notification information including retention address information of the face on which the target face part is not blocked.

In some embodiments, the blocking object display unit 2402 is configured to obtain a trained face detection network, and invoke the face detection network to perform face recognition on the target image, to obtain a face region including the face in the target image; perform region cropping on the target image, to obtain a face image corresponding to the target image, the face image including the face in the target image; obtain a trained face conversion network, and invoke the face conversion network to perform face conversion on the face image, to obtain a converted face image, the target face part in the converted face image being blocked by the target blocking object; and replace the face region in the target image with the converted face image, to obtain a new target image, and display the new target image on the image editing interface.

In some embodiments, the apparatus further includes a training module, configured to obtain a face detection data set, where the face detection data set includes at least one sample image and face annotation information corresponding to each sample image, and the face annotation information is configured for annotating a region in which a face is located in the corresponding sample image; select an i^{th} sample image from the face detection data set, and perform multi-scale feature processing on the i^{th} sample image by using the face detection network, to obtain feature maps of different scales and face prediction information corresponding to each feature map, where the face prediction information is configured for indicating a region in which a face is located and that is obtained through prediction in the corresponding feature map, and i is a positive integer; train the face detection network based on the feature maps of different scales, the face prediction information corresponding to each feature map, and the face annotation information corresponding to the i^{th} sample image, to obtain the trained face detection network; and re-select an (i+1)^{th} sample image from the face detection data set, and perform iterative training on the trained face detection network by using the (i+1)^{th} sample image.

In some embodiments, the face conversion network includes a first image-domain generator, a first image-domain discriminator, a second image-domain generator, and a second image-domain discriminator. The training module is further configured to obtain a face conversion data set, where the face conversion data set includes a plurality of first sample face images belonging to a first image domain and a plurality of second sample face images belonging to a second image domain, a target face part in the first sample face image is not blocked, and a target face part in the second sample face image is blocked; perform image generation on the second sample face image by using the first image-domain generator, to obtain a first reference face image, where a target face part in the first reference face image is not blocked; and perform image generation on the first sample face image by using the second image-domain generator, to obtain a second reference face image, where a target face part in the second reference face image is blocked by a blocking object; perform image discrimination on the first reference face image by using the first image-domain discriminator, and perform image discrimination on the second reference face image by using the second image-domain discriminator, to obtain adversarial generative loss information of the face conversion network; and train the face conversion network based on the adversarial generative loss information, the first reference face image, and the second reference face image.

In some embodiments, the training module is further configured to perform image reconstruction on the first reference face image by using the second image-domain generator, to obtain a second reconstructed face image, a target face part in the second reconstructed face image being blocked by a blocking object; perform image reconstruction on the second reference face image by using the first image-domain generator, to obtain a first reconstructed face image, a target face part in the first reconstructed face image being not blocked; obtain reconstruction loss information of the face conversion network based on similarity between the first reconstructed face image and the corresponding first sample face image and similarity between the second reconstructed face image and the corresponding second sample face image; and train the face conversion network based on the reconstruction loss information and the adversarial generative loss information.

According to some embodiments, the units in the image processing apparatus shown in FIG. 24 may be separately or all combined into one or several other units, or one (or some) of the units may be further split into a plurality of units having smaller functions, so that same operations can be implemented without affecting implementation of the technical effects. The foregoing units are divided based on logical functions. In some embodiments, a function of one unit may be implemented by a plurality of units, or functions of a plurality of units are implemented by one unit. In some embodiments, the image processing apparatus may further include another unit. In some embodiments, the functions may be implemented with assistance of the another unit, and may be implemented with cooperation of a plurality of units.

According to some embodiments, the computer-readable instructions (including the program code) that can perform the operations related to the corresponding methods shown in FIG. 5 and FIG. 16 may be run on a universal computing device, such as a computer, including a processing element and a storage element such as a central processing unit (CPU), a random access memory (RAM), and a read-only memory (ROM), to construct the image processing apparatus shown in FIG. 24, and implement the image processing method according to some embodiments. The computer-readable instructions may be recorded in, for example, a computer-readable recording medium, and are loaded into the computing device by using the computer-readable recording medium, and run in the computing device.

In some embodiments, the face is displayed on the image editing interface. When a user (for example, any user) requires face masking, automatically blocking the target face part (such as a nose part and a mouth part) on the face by using the target blocking object is supported, to implement face masking. In the foregoing solution, when the target face part on the face is blocked by the target blocking object, the target blocking object can adapt to a face posture and flexibly block the target face part on the face. Therefore, the blocked face can still maintain the face appearance attribute of the original face. For example, a posture of the original face is that a head faces upward. In this case, a shape of the target blocking object can change to adapt to the posture of the face, so that the target blocking object whose shape changes can well match the posture of the face. Therefore, it is ensured that a modification trace is basically not formed on the face when sensitive information (for example, information based on which the face can be recognized, such as facial features) on the face is removed, harmony, aesthetics, and naturalness of the blocked face are maintained, and a perception-free face masking effect is provided for the user.

FIG. 25 is a schematic diagram of a structure of a computer device according to some embodiments. Referring to FIG. 25, the computer device includes a processor 2501, a communication interface 2502, and a computer-readable storage medium 2503. The processor 2501, the communication interface 2502, and the computer-readable storage medium 2503 may be connected through a bus or in another manner. The communication interface 2502 is configured to receive and send data. The computer-readable storage medium 2503 may be stored in a memory of a computer device. The computer-readable storage medium 2503 is configured to store computer-readable instructions. The computer-readable instructions include program instructions. The processor 2501 is configured to execute the program instructions stored in the computer-readable storage medium 2503. The processor 2501 (which is also referred to as a central processing unit (CPU)) is a computing core and a control core of a computer device, and is configured to implement one or more instructions, and is configured to load and execute the one or more instructions to implement a corresponding method procedure or a corresponding function.

Some embodiments further provide a computer-readable storage medium (Memory). The computer-readable storage medium is a storage device in a computer device, and is configured to store a program and data. The computer-readable storage medium herein may include a built-in storage medium in the computer device, or may certainly include an extended storage medium supported by the computer device. The computer-readable storage medium provides storage space, and a processing system of the computer device is stored in the storage space. In addition, one or more instructions for being loaded and executed by the processor 2501 are further stored in the storage space, and the instructions may be one or more computer-readable instructions (including program code). The computer-readable storage medium herein may be a high-speed RAM memory, or may be a non-volatile memory, for example, at least one magnetic disk memory. In some embodiments, the computer-readable storage medium may be at least one computer-readable storage medium located away from the processor.

In some embodiments, the computer-readable storage medium stores one or more instructions. The processor 2501 loads and executes the one or more instructions stored in the computer-readable storage medium, to implement the corresponding operations in the foregoing embodiment of the image processing method. During specific implementation, the one or more instructions in the computer-readable storage medium are loaded and executed by the processor 2501 to perform the image processing method in any one of the foregoing embodiments.

In some embodiments, the computer device includes a memory and a processor. The memory stores computer-readable instructions. The computer-readable instructions are executed by the processor 2501, to implement the image processing method in any one of the foregoing embodiments.

Based on a same inventive concept, a principle and beneficial effects of resolving a problem by the computer device provided in some embodiments are similar to a principle and beneficial effects of resolving the problem according to the image processing method in the method embodiments. Refer to the principle and the beneficial effects of implementation of the method. For brief of description, details are not described herein again.

Some embodiments further provide a computer program product. The computer program product includes computer-readable instructions, and the computer-readable instructions are stored in a computer-readable storage medium. A processor of a computer reads the computer-readable instructions from the computer-readable storage medium and executes the computer-readable instructions, to implement the image processing method in any one of the foregoing embodiments.

A person of ordinary skill in the art may be aware that, in combination with the examples described in the embodiments disclosed herein, units and operations may be implemented by electronic hardware or a combination of computer software and electronic hardware. Whether the functions are performed by hardware or software depends on particular applications and design constraints of the technical solutions. A person skilled in the art may use different methods to implement the described functions for each particular application.

All or some of the foregoing embodiments may be implemented by using software, hardware, firmware, or any combination thereof. When the software is used for implementation, implementation may be entirely or partially performed in a form of a computer program product. The computer program product includes one or more computer-readable instructions. When the computer-readable instructions are loaded and executed on the computer, the procedures or functions according to the embodiments of the present disclosure are all or partially generated. The computer may be a general-purpose computer, a dedicated computer, a computer network, or another programmable device. The computer-readable instructions may be stored in the computer-readable storage medium or transmitted through the computer-readable storage medium. The computer-readable instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data processing device, for example, a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid state drive (SSD)), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image processing method, executed by a computer device, comprising:
displaying an image editing interface;
displaying a target image on the image editing interface, the target image comprising a face, the face having a face part and a face appearance attribute, and the face part comprising a target face part to be blocked; and
displaying, on the target face part, a target blocking object blocking the target face part, the face on which the target face part is blocked maintaining the face appearance attribute.

2. The image processing method according to claim 1, wherein the displaying, on the target face part, a target blocking object blocking the target face part comprises:
displaying, on at least one target face part, one target blocking object blocking the at least one target face part.

3. The image processing method according to claim 1, wherein the face appearance attribute comprises at least one of a head orientation, a line of sight, an expression, wearing, or a gender.

4. The image processing method according to claim 1, wherein the displaying, on the target face part, the target blocking object blocking the target face part is triggered based on a blocking trigger operation for the face, wherein
the blocking trigger operation comprises at least one of a trigger operation for a part removal option on the image editing interface, a gesture operation performed on the image editing interface, a speech-signal input operation on the image editing interface, or an operation of determining, through silent detection by an application program, that the target image comprises a face.

5. The image processing method according to claim 1, further comprising:
outputting blocking prompt information in response to a blocking trigger operation for the face, the blocking prompt information prompting to block the target face part on the face; and
triggering, based on a confirmation operation for the blocking prompt information, the operation of displaying, at the target face part, a target blocking object blocking the target face part.

6. The image processing method according to claim 5, wherein the blocking prompt information is displayed in a prompt window, the prompt window further comprises a target face part identifier of the target face part and a part refresh assembly, and the image processing method further comprises:
based on a determination that the part refresh assembly is triggered, displaying, in the prompt window, a candidate face part identifier of a candidate face part on the face, the candidate face part being different from the target face part; and
displaying, at the candidate face part, based on a confirmation operation for the candidate face part identifier, a target blocking object blocking the candidate face part, the face on which the candidate face part is blocked maintaining the face appearance attribute.

7. The image processing method according to claim 1, further comprising:
displaying an object selection interface, the object selection interface comprising one or more candidate blocking objects corresponding to the target face part, and different candidate blocking objects having different object styles; and
determining, as the target blocking object, based on an object selection operation, a candidate blocking object selected from the one or more candidate blocking objects.

8. The image processing method according to claim 1, wherein when the image processing method is applied to a vehicle-mounted scenario, the image processing method further comprising:
displaying face retention prompt information, the face retention prompt information indicating whether to back up the face on which the target face part is not blocked; and
displaying retention notification information based on a confirmation operation for the face retention prompt information, the retention notification information comprising retention address information of the face on which the target face part is not blocked.

9. The image processing method according to claim 1, wherein the displaying, on the target face part, the target blocking object blocking the target face part comprises:
obtaining a trained face detection network, and invoking the trained face detection network to perform face recognition on the target image to obtain a face region comprising the face in the target image;
performing region cropping on the target image, to obtain a face image corresponding to the target image, the face image comprising the face in the target image;
obtaining a trained face conversion network, and invoking the trained face conversion network to perform face conversion on the face image, to obtain a converted face image, the target face part in the converted face image being blocked by the target blocking object; and
replacing the face region in the target image with the converted face image, to obtain a new target image, and displaying the new target image on the image editing interface.

10. The image processing method according to claim 9, wherein a process of training the trained face detection network comprises:
obtaining a face detection data set, wherein the face detection data set comprises at least one sample image and face annotation information corresponding to each sample image, and the face annotation information is configured for annotating a region in which a face is located in the corresponding sample image;
selecting an i^{th} sample image from the face detection data set, and performing multi-scale feature processing on the i^{th} sample image by using a face detection network, to obtain feature maps of different scales and face prediction information corresponding to each feature map, wherein the face prediction information is configured for indicating a region in which a face is located and that is obtained through prediction in the corresponding feature map, and i is a positive integer;
training the face detection network based on the feature maps of different scales, the face prediction information corresponding to each feature map, and the face annotation information corresponding to the i^{th} sample image, to obtain the trained face detection network; and
re-selecting an (i+1)^{th} sample image from the face detection data set, and performing iterative training on the trained face detection network by using the (i+1)^{th} sample image.

11. The image processing method according to claim 9, wherein the face conversion network comprises a first image-domain generator, a first image-domain discriminator, a second image-domain generator, and a second image-domain discriminator; and a process of training the face conversion network comprises:
obtaining a face conversion data set, wherein the face conversion data set comprises a plurality of first sample face images belonging to a first image domain and a plurality of second sample face images belonging to a second image domain, a target face part in the first sample face image is not blocked, and a target face part in the second sample face image is blocked;
performing image generation on the second sample face image by using the first image-domain generator, to obtain a first reference face image, wherein a target face part in the first reference face image is not blocked; and performing image generation on the first sample face image by using the second image-domain generator, to obtain a second reference face image, wherein a target face part in the second reference face image is blocked by a blocking object;
performing image discrimination on the first reference face image by using the first image-domain discriminator, and performing image discrimination on the second reference face image by using the second image-domain discriminator, to obtain adversarial generative loss information of the face conversion network; and
training the face conversion network based on the adversarial generative loss information, the first reference face image, and the second reference face image.

12. The image processing method according to claim 11, wherein the training the face conversion network based on the adversarial generative loss information, the first reference face image, and the second reference face image comprises:
performing image reconstruction on the first reference face image by using the second image-domain generator, to obtain a second reconstructed face image, a target face part in the second reconstructed face image being blocked by a blocking object;
performing image reconstruction on the second reference face image by using the first image-domain generator, to obtain a first reconstructed face image, a target face part in the first reconstructed face image being not blocked;
obtaining reconstruction loss information of the face conversion network based on similarity between the first reconstructed face image and the corresponding first sample face image and similarity between the second reconstructed face image and the corresponding second sample face image; and
training the face conversion network based on the reconstruction loss information and the adversarial generative loss information.

13. An image processing apparatus, comprising:
at least one memory configured to store computer program code; and
at least one processor configured to read the program code and operate as instructed by the program code, the program code comprising:
interface display code configured to cause at least one of the at least one processor to display an image editing interface; and display a target image on the image editing interface, the target image comprising a face, the face having a face part and a face appearance attribute, and the face part comprising a target face part to be blocked; and
blocking object display code configured to cause at least one of the at least one processor to display, on the target face part, a target blocking object blocking the target face part, the face on which the target face part is blocked maintaining the face appearance attribute.

14. The image processing apparatus according to claim 13, wherein the blocking object display code is further configured to cause at least one of the at least one processor to:
display, on at least one target face part, one target blocking object blocking the at least one target face part.

15. The image processing apparatus according to claim 13, wherein the face appearance attribute comprises at least one of a head orientation, a line of sight, an expression, wearing, or a gender.

16. The image processing apparatus according to claim 13, wherein the blocking object display code is further configured to cause at least one of the at least one processor to trigger the display, on the target face part, the target blocking object blocking the target face part based on a blocking trigger operation for the face, wherein
the blocking trigger operation comprises at least one of a trigger operation for a part removal option on the image editing interface, a gesture operation performed on the image editing interface, a speech-signal input operation on the image editing interface, or an operation of determining, through silent detection by an application program, that the target image comprises a face.

17. The image processing apparatus according to claim 13, wherein the blocking object display code is further configured to cause at least one of the at least one processor to:
output blocking prompt information in response to a blocking trigger operation for the face, the blocking prompt information prompting to block the target face part on the face; and
trigger, based on a confirmation operation for the blocking prompt information, the operation of displaying, at the target face part, a target blocking object blocking the target face part.

18. The image processing apparatus according to claim 17, wherein the blocking prompt information is displayed in a prompt window, the prompt window further comprises a target face part identifier of the target face part and a part refresh assembly, and the blocking object display code is further configured to cause at least one of the at least one processor to:
based on a determination that the part refresh assembly is triggered, display, in the prompt window, a candidate face part identifier of a candidate face part on the face, the candidate face part being different from the target face part; and
display, at the candidate face part, based on a confirmation operation for the candidate face part identifier, a target blocking object blocking the candidate face part, the face on which the candidate face part is blocked maintaining the face appearance attribute.

19. The image processing apparatus according to claim 13, wherein the blocking object display code is further configured to cause at least one of the at least one processor to:
display an object selection interface, the object selection interface comprising one or more candidate blocking objects corresponding to the target face part, and different candidate blocking objects having different object styles; and
determine, as the target blocking object, based on an object selection operation, a candidate blocking object selected from the one or more candidate blocking objects.

20. A non-transitory computer-readable storage medium, storing computer code which, when executed by at least one processor, causes the at least one processor to at least:
display an image editing interface;
display a target image on the image editing interface, the target image comprising a face, the face having a face part and a face appearance attribute, and the face part comprising a target face part to be blocked; and
display, on the target face part, a target blocking object blocking the target face part, the face on which the target face part is blocked maintaining the face appearance attribute.
